(19) United States
(12) Patent Application Publication
(10) Pub. No.: US 2021/0201002 A1
(43) Pub. Date: Jul. 1, 2021

(54) MOVING IMAGE DISTRIBUTION COMPUTER PROGRAM, SERVER DEVICE, AND METHOD

(71) Applicant: GREE, Inc., Tokyo (JP)

(72) Inventors: Masashi WATANABE, Tokyo (JP); Hisashi KAWAMURA, Tokyo (JP)

(73) Assignee: GREE, Inc., Tokyo (JP)

(21) Appl. No.: 17/077,135

(22) Filed: Oct. 22, 2020

(30) Foreign Application Priority Data
Dec. 27, 2019 (JP) 2019-239318

(51) Int. Cl. G06K 9/00; G06T 7/20; G06T 13/40

(52) U.S. Cl. CPC G06K 9/00302; G06K 9/00281; G06T 2207/30201; G06T 7/20; G06T 13/40; G06K 9/00342

(57) ABSTRACT

A computer program causes one or more processors to execute: retrieving a change amount of each of a plurality of specific portions of a body on the basis of data regarding a motion of the body retrieved by a sensor; determining that a specific facial expression or motion is formed in a case where all change amounts of one or more specific portions specified in advance among the change amounts of the plurality of specific portions exceed respective threshold values; and generating an image or a moving image in which a specific expression corresponding to the determined specific facial expression or motion is reflected on an avatar object corresponding to a performer.

### CROSS REFERENCE TO RELATED APPLICATIONS

This application claims priority to Japanese Patent Application No. 2019-239318 filed Dec. 27, 2019, the contents of which is incorporated herein by reference in its entirety.

### BACKGROUND

### Technical Field

The technology disclosed in the present application relates to a computer program, a server device, and a method regarding moving image (e.g., video) distribution.

### Related Art

Conventionally, a moving image distribution service which distributes a moving image to a terminal device via a network is known. In this type of moving image distribution service, an environment is provided on which an avatar object corresponding to a distribution user (e.g., performer) who distributes the moving image is displayed.

As for the moving image distribution service, a service called “custom cast” is known as a service which uses a technology for controlling the facial expression or motion of the avatar object on the basis of the motion of the performer or the like (“Custom Cast”, [online], Custom Cast Inc., [Searched Dec. 10, 2019], Internet (URL: https://customcast.jp/)). In this service, the performer pre-assigns one facial expression or motion of a number of prepared facial expressions or motions to each of a plurality of flick directions with respect to a screen of a smartphone, and at the time of moving image distribution, when the performer flicks the screen of the smartphone along the direction corresponding to a desired facial expression or motion, the facial expression or motion can be expressed on the avatar object displayed in the moving image.

“Custom Cast”, [online], Custom Cast Inc., [Searched Dec. 10, 2019], Internet (URL: https://customcast.jp/) is incorporated herein by reference in its entirety.

However, in the technology disclosed in “Custom Cast”, [online], Custom Cast Inc., [Searched Dec. 10, 2019], Internet (URL: https://customcast.jp/), in order to distribute a moving image, the performer necessarily flicks the screen of the smartphone while speaking, and it is difficult for the performer to operate the flick, and an erroneous operation of the flick is likely to occur.

### SUMMARY

Some embodiments disclosed in the present application may address issues encountered with the related art, and may provide a computer program, a server device, and a method in which a performer or the like can easily and accurately cause an avatar object to express a desired facial expression or motion.

A computer program according to one aspect causes one or more processors to execute a method of: retrieving a change amount of each of a plurality of specific portions of a body on the basis of data regarding a motion of the body retrieved by a sensor; determining that a specific facial expression or motion is formed in a case where all change amounts of one or more specific portions specified in advance among the change amounts of the plurality of specific portions exceed respective threshold values; and generating an image or a moving image in which a specific expression corresponding to the determined specific facial expression or motion is reflected on an avatar object corresponding to a performer.

A server device according to one aspect includes: a processor. The processor executes computer readable instructions to perform retrieving a change amount of each of a plurality of specific portions of a body on the basis of data regarding a motion of the body retrieved by a sensor, determining that a specific facial expression or motion is formed in a case where all change amounts of one or more specific portions specified in advance among the change amounts of the plurality of specific portions exceed respective threshold values, and generating an image or a moving image in which a specific expression corresponding to the determined specific facial expression or motion is reflected on an avatar object corresponding to a performer.

A method according to one aspect is executed by one or more processors executing computer readable instructions. The method includes: a change amount retrieval process of retrieving a change amount of each of a plurality of specific portions of a body on the basis of data regarding a motion of the body retrieved by a sensor; a determination process of determining that a specific facial expression or motion is formed in a case where all change amounts of one or more specific portions specified in advance among the change amounts of the plurality of specific portions exceed respective threshold values; and a generation process of generating an image or a moving image in which a specific expression corresponding to the specific facial expression or motion determined by the determination process is reflected on an avatar object corresponding to a performer.

### BRIEF DESCRIPTION OF DRAWINGS

FIG. 1 is a block diagram illustrating an example of a configuration of a communication system according to an embodiment;

FIG. 2 is a block diagram schematically illustrating an example of a hardware configuration of a terminal device (server device) illustrated in FIG. 1;

FIG. 3 is a block diagram schematically illustrating an example of functions of a studio unit illustrated in FIG. 1;

FIG. 4A is a diagram illustrating a relationship between a specific portion specified corresponding to a specific facial expression “close one eye (wink)” and the threshold value thereof;

FIG. 4B is a diagram illustrating a relationship between a specific portion specified corresponding to a specific facial expression “laughing face” and the threshold value thereof;

FIG. 5 is a diagram illustrating a relationship between a specific facial expression or motion and a specific expression (specific motion or facial expression);

FIG. 6 is a diagram schematically illustrating an example of a user interface part;

FIG. 7 is a diagram schematically illustrating an example of the user interface part;

FIG. 8 is a diagram schematically illustrating an example of the user interface part;

FIG. 9 is a flowchart illustrating an example of a part of an operation performed in the communication system illustrated in FIG. 1;

FIG. 10 is a flowchart illustrating an example of a part of the operation performed in the communication system illustrated in FIG. 1; and

FIG. 11 is a diagram illustrating a modification of a third user interface part.

### DETAILED DESCRIPTION

Hereinafter, various embodiments of the present invention will be described with reference to the accompanying drawings. Incidentally, in the drawings, common components are designated by the same reference numerals. Further, it should be noted that the components expressed in one drawing may be omitted in another drawing for convenience of description. Furthermore, it should be noted that the attached drawings are not necessarily on an accurate scale. Furthermore, the term “application” may include or cover software or a program, and in some embodiments an application may be a command issued to a computer that is combined to obtain a certain result. As used herein, unless specifically stated otherwise, the term “or” encompasses all possible combinations, except where infeasible. For example, if it is stated that a component includes A or B, then, unless specifically stated otherwise or infeasible, the component may include A, or B, or A and B. As a second example, if it is stated that a component includes A, B, or C, then, unless specifically stated otherwise or infeasible, the component may include A, or B, or C, or A and B, or A and C, or B and C, or A and B and C. Expressions such as “at least one of” do not necessarily modify an entirety of a following list and do not necessarily modify each member of the list, such that “at least one of A, B, and C” should be understood as including only one of A, only one of B, only one of C, or any combination of A, B, and C. The phrase “one of A and B” or “any one of A and B” shall be interpreted in the broadest sense to include one of A, or one of B.

1. Configuration of Communication System

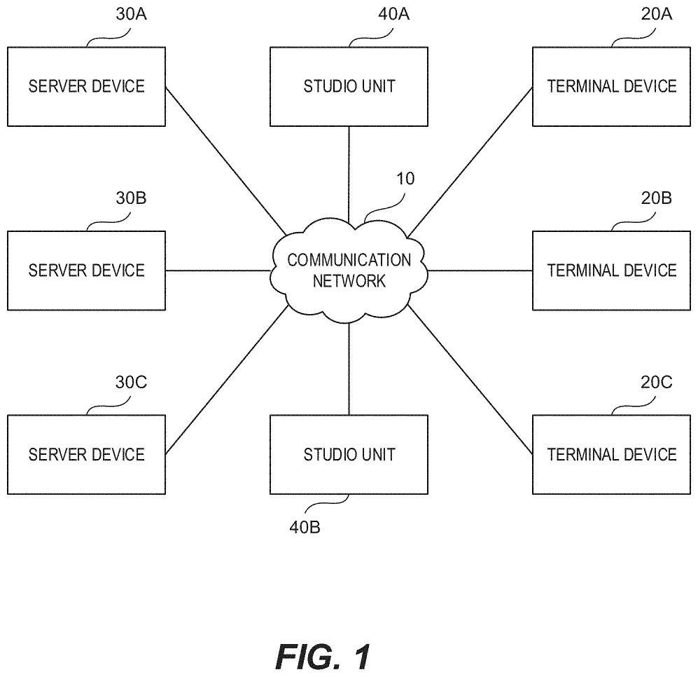

FIG. 1 is a block diagram illustrating an example of a configuration of a communication system 1 according to an embodiment. As illustrated in FIG. 1, the communication system 1 may include one or more terminal devices 20 connected to a communication network 10 and one or more server devices 30 connected to the communication network 10. Incidentally, in FIG. 1, three terminal devices 20A to 20C are illustrated as an example of the terminal device 20, and three server devices 30A to 30C are illustrated as an example of the server device 30. However, in addition thereto, as the terminal device 20, one or more terminal devices 20 may be connected to the communication network 10, and as the server device 30, one or more server devices 30 may be connected to the communication network 10.

The communication system 1 may also include one or more studio units 40 connected to the communication network 10. Incidentally, in FIG. 1, two studio units 40A and 40B are illustrated as an example of the studio unit 40. However, in addition thereto, as the studio unit 40, one or more studio units 40 may be connected to the communication network 10.

In a “first aspect”, in the communication system 1 illustrated in FIG. 1, for example, the studio unit 40 installed in a studio room or the like or another place retrieves the data regarding the body of a performer or the like in the studio room or the like or the other place, then retrieves the change amount of each of a plurality of portions (e.g., specific portions) of the body of the performer or the like on the basis of this data, and generates a moving image (or an image) in which a predetermined specific expression is reflected on the avatar object corresponding to the performer when it is determined that all the change amounts of the specific portions exceed respective threshold values. Then, the studio unit 40 can transmit the generated moving image to the server device 30, and the server device 30 can distribute the moving image retrieved (e.g., received) from the studio unit 40 via the communication network 10 to one or more terminal devices 20 which transmit signals to request the distribution of the moving image by executing a specific application (e.g., an application for watching moving images).

Herein, in the “first aspect”, instead of a configuration in which the studio unit 40 generates a moving image in which a predetermined specific expression is reflected on the avatar object corresponding to the performer and transmits the moving image to the server device 30, a rendering system configuration may be adopted in which the studio unit 40 transmits data regarding the body of the performer or the like and data (e.g., data regarding the above-described determination) regarding the change amount of each of a plurality of specific portions of the body of the performer or the like based on the data to the server device 30, and the server device 30 generates a moving image in which a predetermined specific expression is reflected on the avatar object corresponding to the performer in accordance with the data received from the studio unit 40. Alternatively, a rendering system configuration may be adopted in which the studio unit 40 transmits data regarding the body of the performer or the like and data (e.g., data regarding the above-described determination) regarding the change amount of each of a plurality of specific portions of the body of the performer or the like based on the data to the server device 30, the server device 30 transmits the data received from the studio unit 40 to the terminal device 20, and the terminal device 20 generates a moving image in which a predetermined specific expression is reflected on the avatar object corresponding to the performer in accordance with the data received from the server device 30.

In a “second aspect”, in the communication system 1 illustrated in FIG. 1, for example, the terminal device 20 (for example, a terminal device 20A) which is operated by the performer or the like and executes a specific application (such as an application for moving image distribution) retrieves the data regarding the body of the performer or the like facing the terminal device 20A, then retrieves the change amount of each of a plurality of specific portions of the body of the performer or the like on the basis of this data, and generates a moving image (or an image) in which a predetermined specific expression is reflected on the avatar object corresponding to the performer when it is determined that all the change amounts of the specific portions exceed respective threshold values. Then, the terminal device 20A can transmit the generated moving image to the server device 30, and the server device 30 can distribute the moving image retrieved (e.g., received) from the terminal device 20A via the communication network 10 to other one or more terminal devices 20 (for example, a terminal device 20C) which transmit signals to request the distribution of the moving image by executing a specific application (e.g., an application for watching moving images).

Herein, in the “second aspect”, instead of a configuration in which the terminal device 20 (e.g., terminal device 20A) generates a moving image in which a predetermined specific expression is reflected on the avatar object corresponding to the performer and transmits the moving image to the server device 30, a rendering system configuration may be adopted in which the terminal device 20 transmits data regarding the body of the performer or the like and data (e.g., data regarding the above-described determination) regarding the change amount of each of a plurality of specific portions of the body of the performer or the like based on the data to the server device 30, and the server device 30 generates a moving image in which a predetermined specific expression is reflected on the avatar object corresponding to the performer in accordance with the data received from the terminal device 20. Alternatively, a rendering system configuration may be adopted in which the terminal device 20 (e.g., terminal device 20A) transmits data regarding the body of the performer or the like and data (e.g., data regarding the above-described determination) regarding the change amount of each of a plurality of specific portions of the body of the performer or the like based on the data to the server device 30, the server device 30 transmits the data received from the terminal device 20A to other one or more terminal devices 20 (for example, the terminal device 20C) which transmit signals to request the distribution of the moving image by executing a specific application, and the terminal device 20C generates a moving image in which a predetermined specific expression is reflected on the avatar object corresponding to the performer in accordance with the data received from the server device 30.

In a “third aspect”, in the communication system 1 illustrated in FIG. 1, for example, the server device 30 (for example, a server device 30B) installed in a studio room or the like or another place retrieves the data regarding the body of a performer or the like in the studio room or the like or the other place, then retrieves the change amount of each of a plurality of portions (e.g., specific portions) of the body of the performer or the like on the basis of this data, and generates a moving image (or an image) in which a predetermined specific expression is reflected on the avatar object corresponding to the performer when it is determined that all the change amounts of the specific portions exceed respective threshold values. Then, the server device 30B can distribute the generated moving image via the communication network 10 to one or more terminal devices 20 which transmit signals to request the distribution of the moving image by executing a specific application (e.g., an application for watching moving images). Also in the “third aspect”, similarly to the above, instead of a configuration in which the server device 30 (e.g., server device 30B) generates a moving image in which a predetermined specific expression is reflected on the avatar object corresponding to the performer and transmits the moving image to the terminal device 20, a rendering system configuration may be adopted in which server device 30 transmits data regarding the body of the performer or the like and data (e.g., data regarding the above-described determination) regarding the change amount of each of a plurality of specific portions of the body of the performer or the like based on the data to the terminal device 20, and the terminal device 20 generates a moving image in which a predetermined specific expression is reflected on the avatar object corresponding to the performer in accordance with the data received from the server device 30.

The communication network 10 may include a mobile phone network, a wireless LAN, a fixed telephone network, the Internet, an intranet, or Ethernet (registered trademark) without being limited thereto.

The above-described performer or the like may include not only a performer but also, for example, a supporter who is present with the performer in the studio room or the like or other places, and an operator of the studio unit.

By executing the installed specific application, the terminal device 20 can execute an operation or the like of retrieving the data regarding the body of the performer or the like, then retrieving the change amount of each of a plurality of portions (e.g., specific portions) of the body of the performer or the like on the basis of this data, generating a moving image (or an image) in which a predetermined specific expression is reflected on the avatar object corresponding to the performer when it is determined that all the change amounts of the specific portions exceed respective threshold values, and then transmitting the generated moving image to the server device 30. Alternatively, by executing an installed web browser, the terminal device 20 can receive and display a web page from the server device 30 and perform the same operation or the like.

The terminal device 20 is any terminal device capable of executing such an operation and may include a smartphone, a tablet, a mobile phone (e.g., feature phone), a personal computer, or the like without being limited thereto.

In the “first aspect” and the “second aspect”, by executing the installed specific application to function as an application server, the server device 30 can execute an operation or the like of receiving a moving image in which a predetermined specific expression is reflected on the avatar object from the studio unit 40 or the terminal device 20 via the communication network 10 and distributing the received moving image (e.g., together with other moving images) to each terminal device 20 via the communication network 10. Alternatively, by executing the installed specific application to function as a web server, the server device 30 can execute the same operation or the like via the web page transmitted to each terminal device 20.

In the “third aspect”, by executing the installed specific application to function as an application server, the server device 30 can execute an operation or the like of retrieving the data regarding the body of the performer or the like in the studio room or the like in which the server device 30 is installed or another place, then retrieving the change amount of each of a plurality of portions (e.g., specific portions) of the body of the performer or the like on the basis of this data, generating a moving image (or an image) in which a predetermined specific expression is reflected on the avatar object corresponding to the performer when it is determined that all the change amounts the specific portions exceed respective threshold values, and distributing the generated moving image (e.g., together with other moving images) to each terminal device 20 via the communication network 10. Alternatively, by executing the installed specific application to function as a web server, the server device 30 can execute the same operation or the like via the web page transmitted to each terminal device 20.

By functioning as an information processing device which executes the installed specific application, the studio unit 40 can execute an operation or the like of retrieving the data regarding the body of the performer or the like in the studio room or the like in which the studio unit 40 is installed or another place, then retrieving the change amount of each of a plurality of portions (e.g., specific portions) of the body of the performer or the like on the basis of this data, generating a moving image (or an image) in which a predetermined specific expression is reflected on the avatar object corresponding to the performer when it is determined that all the change amounts of the specific portions exceed respective threshold values, and transmitting the generated moving image (e.g., together with other moving images) to the server device 30 via the communication network 10.

2. Hardware Configuration of Each Device

Next, an example of the hardware configuration of each of the terminal device 20, the server device 30, and the studio unit 40 will be described.

2-1. Hardware Configuration of Terminal Device 20

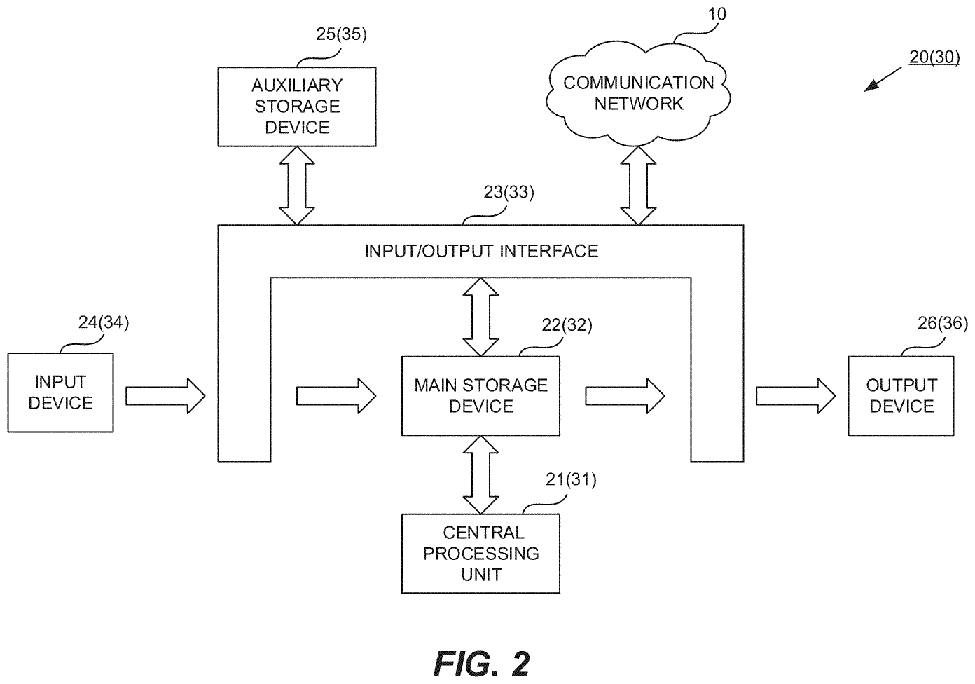

An example of the hardware configuration of each terminal device 20 is described with reference to FIG. 2. FIG. 2 is a block diagram schematically illustrating an example of the hardware configuration of the terminal device 20 illustrated in FIG. 1 (incidentally, in FIG. 2, a reference numeral in parentheses is attached in relation to each server device 30 as described later).

As illustrated in FIG. 2, each terminal device 20 may include mainly a central processing unit 21, a main storage device 22, an input/output interface 23, an input device 24, an auxiliary storage device 25, and an output device 26. These devices are connected to each other by a data bus or a control bus.

The central processing unit 21 is referred to as a “CPU”, which performs a calculation on the instructions and data stored in the main storage device 22 and causes the main storage device 22 to store the result of the calculation. Further, the central processing unit 21 can control the input device 24, the auxiliary storage device 25, the output device 26, and the like via the input/output interface 23. The terminal device 20 may include one or more such central processing units 21.

The main storage device 22 is referred to as a “memory”, which stores the instructions and data, which are received from the input device 24, the auxiliary storage device 25, the communication network 10, and the like (e.g., the server device 30 and the like) via the input/output interface 23, and the calculation result of the central processing unit 21. The main storage device 22 can include a random access memory (RAM), a read only memory (ROM), a flash memory, or the like without being limited thereto.

The auxiliary storage device 25 is a storage device having a larger capacity than the main storage device 22. The above-described specific applications (e.g., an application for moving image distribution, an application for watching moving images, and the like) and the instructions and data (e.g., computer program) which configure a web browser and the like can be stored, and the instructions and data (e.g., computer program) can be transmitted to the main storage device 22 via the input/output interface 23 by the control of the central processing unit 21. The auxiliary storage device 25 may include a magnetic disk device, an optical disk device, or the like without being limited thereto.

The input device 24 is a device for fetching data from the outside, and includes a touch panel, buttons, a keyboard, a mouse, a sensor, or the like without being limited thereto. As described later, the sensor may include a sensor including one or more cameras, one or more microphones, or the like without being limited thereto.

The output device 26 may include a display device, a touch panel, a printer device, or the like without being limited thereto.

In such a hardware configuration, the central processing unit 21 can sequentially load the instructions and data (e.g., computer program) configuring the specific application stored in the auxiliary storage device 25 into the main storage device 22 and calculate the loaded instruction and data to control the output device 26 via the input/output interface 23 or to transmit and receive various kinds of information to/from another device (for example, the server device 30, the studio unit 40, and other terminal devices 20) via the input/output interface 23 and the communication network 10.

Accordingly, by executing the installed specific application, the terminal device 20 can execute an operation or the like of retrieving the data regarding the body of the performer or the like, then retrieving the change amount of each of a plurality of portions (e.g., specific portions) of the body of the performer or the like on the basis of this data, generating a moving image (or an image) in which a predetermined specific expression is reflected on the avatar object corresponding to the performer when all the change amounts of the specific portions exceed respective threshold values, and then transmitting the generated moving image to the server device 30. Alternatively, by executing an installed web browser, the terminal device 20 can receive and display a web page from the server device 30 and perform the same operation or the like.

Incidentally, the terminal device 20 may include one or more microprocessors or a graphics processing unit (GPU) instead of the central processing unit 21 or together with the central processing unit 21.

2-2. Hardware Configuration of Server Device 30

An example of the hardware configuration of each server device 30 is described similarly with reference to FIG. 2. For example, the hardware configuration of each server device 30 may be the same as the hardware configuration of each terminal device 20 described above. Therefore, the reference numerals for the components included in each server device 30 are shown in parentheses in FIG. 2.

As illustrated in FIG. 2, each server device 30 may include mainly a central processing unit 31, a main storage device 32, an input/output interface 33, an input device 34, an auxiliary storage device 35, and an output device 36. These devices are connected to each other by a data bus or a control bus.

The central processing unit 31, the main storage device 32, the input/output interface 33, the input device 34, the auxiliary storage device 35, and the output device 36 are included in each of the terminal devices 20 described above and may be substantially the same as the central processing unit 21, and the main storage device 22, the input/output interface 23, the input device 24, the auxiliary storage device 25, and the output device 26.

In such a hardware configuration, the central processing unit 31 can sequentially load the instructions and data (e.g., computer program) configuring the specific application stored in the auxiliary storage device 35 into the main storage device 32 and calculate the loaded instruction and data to control the output device 36 via the input/output interface 33 or to transmit and receive various kinds of information to/from another device (for example, each terminal device 20 and the studio unit 40) via the input/output interface 33 and the communication network 10.

Accordingly, in the “first aspect” and the “second aspect”, by executing the installed specific application to function as an application server, the server device 30 can execute an operation or the like of receiving a moving image in which a predetermined specific expression is reflected on the avatar object from the studio unit 40 or the terminal device 20 via the communication network 10 and distributing the received moving image (e.g., together with other moving images) to each terminal device 20 via the communication network 10. Alternatively, by executing the installed specific application to function as a web server, the server device 30 can execute the same operation or the like via the web page transmitted to each terminal device 20.

In the “third aspect”, by executing the installed specific application to function as an application server, the server device 30 can execute an operation or the like of retrieving the data regarding the body of the performer or the like in the studio room or the like in which the server device 30 is installed or another place, then retrieving the change amount of each of a plurality of portions (e.g., specific portions) of the body of the performer or the like on the basis of this data, generating a moving image (or an image) in which a predetermined specific expression is reflected on the avatar object corresponding to the performer when all the change amounts of the specific portions exceed respective threshold values, and distributing the generated moving image (e.g., together with other moving images) to each terminal device 20 via the communication network 10. Alternatively, by executing the installed specific application to function as a web server, the server device 30 can execute the same operation or the like via the web page transmitted to each terminal device 20.

Incidentally, the server device 30 may include one or more microprocessors or a graphics processing unit (GPU) instead of the central processing unit 31 or together with the central processing unit 31.

2-3. Hardware Configuration of Studio Unit 40

The studio unit 40 can be mounted in an information processing device such as a personal computer and is not illustrated in the drawing. However, similarly to the terminal device 20 and the server device 30, the studio unit may include mainly a central processing unit, a main storage device, an input/output interface, an input device, an auxiliary storage device, and an output device. These devices are connected to each other by a data bus or a control bus.

By executing the installed specific application to function as an information processing device, the studio unit 40 can execute an operation or the like of retrieving the data regarding the body of the performer or the like in the studio room or the like in which the studio unit 40 is installed or another place, then retrieving the change amount of each of a plurality of portions (e.g., specific portions) of the body of the performer or the like on the basis of this data, generating a moving image (or an image) in which a predetermined specific expression is reflected on the avatar object corresponding to the performer when all the change amounts of the specific portions exceed respective threshold values, and transmitting the generated moving image (e.g., together with other moving images) to the server device 30 via the communication network 10.

3. Functions of Each Device

Next, an example of the functions of each of the studio unit 40, the terminal device 20, and the server device 30 is described.

3-1. Functions of Studio Unit 40

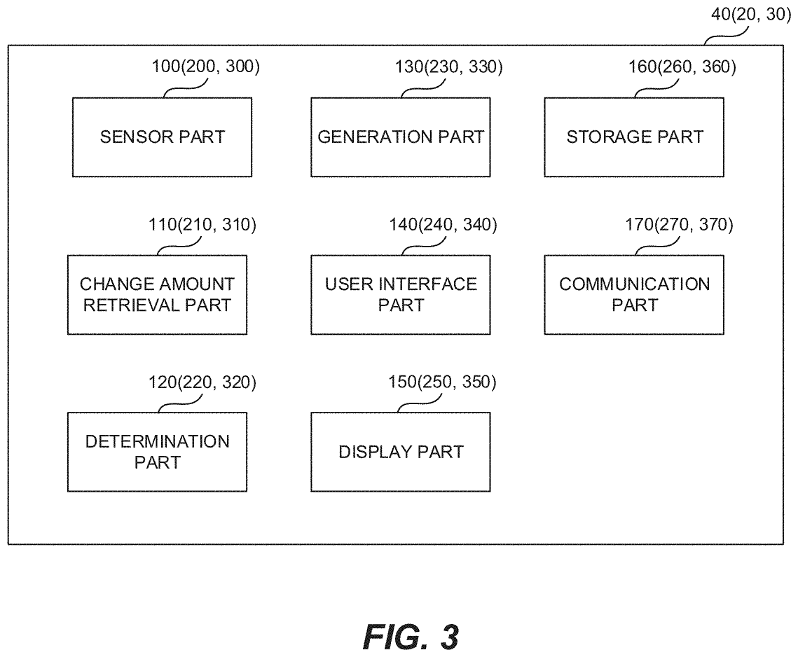

An example (one embodiment) of the functions of the studio unit 40 is described with reference to FIG. 3. FIG. 3 is a block diagram schematically illustrating an example of the functions of the studio unit 40 illustrated in FIG. 1 (incidentally, in FIG. 3, a reference numeral in parentheses is attached in relation to the terminal device 20 and the server device 30 as described later).

As illustrated in FIG. 3, the studio unit 40 includes a sensor part 100 which retrieves data regarding the body of the performer or the like from a sensor, a change amount retrieval part 110 which retrieves a change amount of each of a plurality of specific portions of the body of the performer or the like on the basis of the data retrieved from the sensor part 100, a determination part 120 which determines whether or not all the change amounts of one or more specific portions specified in advance among the change amounts of the plurality of specific portions exceed respective threshold values and then, in the case of determination of exceeding, determines that the performer or the like forms a specific facial expression, and a generation part 130 which generates a moving image (or an image) in which a specific expression corresponding to the specific facial expression determined by the determination part 120 is reflected on the avatar object corresponding to the performer.

The studio unit 40 may further include a user interface part 140 in which the performer or the like can appropriately set each of the above-described threshold value.

The studio unit 40 may include a display part 150 which displays the moving image (or the image) generated by the generation part 130, a storage part 160 which stores the moving image generated by the generation part 130, and a communication part 170 which performs transmission or the like of the moving image generated by the generation part 130 to the server device 30 via the communication network 10.

(1) Sensor Part 100

The sensor part 100 is arranged, for example, in a studio room (not illustrated). In the studio room, the performer performs various performances, and the sensor part 100 detects the motion, facial expression, utterance (e.g., singing), and the like of the performer.

The performer is a target of which the motion, facial expression, utterance (e.g., singing), and the like are captured by various sensor groups included in the studio room. In this case, the number of performers present in the studio room may be one or two or more.

The sensor part 100 may include one or more first sensors (not illustrated) which retrieve data regarding the body such as the face, limbs, and the like of the performer and one or more second sensors (not illustrated) which retrieves voice data regarding the utterance or singing uttered by the performer.

In an embodiment, the first sensor may include at least an RGB camera which captures visible light and a near-infrared camera which captures near-infrared light. Further, the first sensor may include a motion sensor, a tracking sensor, and the like described later. For example, the above-described RGB camera and near-infrared camera may be those included in the True Depth camera of iPhone X (registered trademark). The second sensor may include a microphone which records voice.

As for the first sensor, the sensor part 100 images the face, limbs, and the like of the performer by using the first sensor (e.g., a camera included in the first sensor) arranged in proximity to the face, limbs, and the like of the performer. Accordingly, the sensor part 100 can generate data (for example, an MPEG file) in which the images retrieved by the RGB camera are recorded in association with a time code (e.g., a code indicating the retrieval time) over unit time sections. Further, the sensor part 100 can generate data (for example, a TSV file [a file in a form in which a plurality of pieces of data is recorded with data separated with tabs]) in which a numerical value (for example, a floating-point value) indicating a predetermined number (for example, 51) of depths retrieved by a near-infrared camera is recorded in association with the time code over a unit time.

As for the near-infrared camera, specifically, the dot projector emits an infrared laser forming a dot pattern on the face, limbs, and the like of the performer, and the near-infrared camera captures infrared dots which are projected on the face, limbs, and the like of the performer to be reflected and generates an image of the infrared dots captured in this way. The sensor part 100 can compare an image of a dot pattern emitted by a dot projector registered in advance with the image captured by the near infrared camera and calculate a depth (e.g., a distance between each point/each feature point and the near-infrared camera) of each point (e.g., each feature point) by using a positional deviation at each point (e.g., each feature point) (for example, each of 51 points/feature points) in both images. The sensor part 100 can generate data in which the numerical value indicating the depth calculated in this way is recorded over a unit time in association with the time code as described above.

The sensor part 100 in the studio room may have various motion sensors (not illustrated) attached to the body (for example, a wrist, an in step, a waist, and a crown) of the performer, a controller (not illustrated) held by the hand of the performer, and the like. Furthermore, in addition to the above-described components, the studio room may have a plurality of base stations (not illustrated), a tracking sensor (not illustrated), and the like.

The above-described motion sensor can cooperate with the above-described base station to detect the position and orientation of the performer. In one embodiment, the plurality of base stations are multi-axis laser emitters and are configured such that, after emitting a blinking light for synchronization, one base station scans a laser light, for example, about a vertical axis, and another base station scans a laser light, for example, around a horizontal axis. The motion sensor is provided with a plurality of optical sensors which detect the incidence of the blinking light and the laser light from the base station and can detect a time difference between the incidence timing of the blinking light and the incidence timing of the laser light, a light reception time at each optical sensor, the incident angle of the laser light detected by each optical sensor, and the like. For example, the motion sensor may be Vive Tracker provided by HTC CORPORATION or Xsens MVN Analyze provided by ZERO C SEVEN Inc.

The sensor part 100 can retrieve detection information indicating the position and orientation of each motion sensor calculated by the motion sensor. The motion sensor is attached to a portion such as a wrist, an in step, a waist, and a crown of the performer, thereby detecting the position and orientation of the motion sensor and detecting the movement of each portion of the body of the performer. Incidentally, the detection information indicating the position and orientation of the motion sensor is calculated as a position coordinate value in an XYZ coordinate system for each portion of the body of the performer in the moving image (e.g., in the virtual space included in the moving image). For example, an X axis is set to correspond to a horizontal direction in the moving image, a Y axis is set to correspond to a depth direction in the moving image, and a Z axis is set to correspond to a vertical direction in the moving image. Therefore, all movements of each portion of the body of the performer are also detected as position coordinate values in the XYZ coordinate system.

In one embodiment, a large number of infrared LEDs may be mounted on a plurality of motion sensors, and the position and orientation of the motion sensors may be detected by detecting the light from the infrared LEDs with an infrared camera provided on the floor or wall of the studio room. Further, a visible light LED may be used instead of the infrared LED, and the position and orientation of the motion sensor may be detected by detecting the light from the visible light LED with a visible light camera.

In one embodiment, a plurality of reflective markers may be used instead of the motion sensor. The reflective marker is stuck to the performer with an adhesive tape or the like. In this way, the performer stuck with the reflective marker may be imaged to generate an image data, and image processing is performed on the image data to detect the position and orientation of the reflective marker (e.g., position coordinate values in the XYZ coordinate system as described above).

The controller outputs a control signal according to an operation such as bending of a finger by the performer, and the generation part 130 retrieves the control signal.

The tracking sensor generates tracking information for defining setting information of a virtual camera for constructing a virtual space included in a moving image. The tracking information is calculated as a position in a three-dimensional orthogonal coordinate system and an angle around each axis, and the generation part 130 retrieves the tracking information.

Next, as for the second sensor, the sensor part 100 retrieves a voice regarding the utterance or the singing uttered by the performer by using the second sensor arranged in proximity to the performer. Accordingly, the sensor part 100 can generate data (for example, an MPEG file) recorded over a unit time in association with the time code. In one embodiment, the sensor part 100 can retrieve data regarding the face or limbs of the performer by using the first sensor and simultaneously retrieve voice data regarding the utterance or singing uttered by the performer by using the second sensor. In this case, the sensor part 100 can generate data (for example, an MPEG file) in which the image retrieved by the RGB camera and the voice data retrieved by using the second sensor and regarding the utterance or the singing uttered by the performer are recorded over a unit time in association with the same time code.

The sensor part 100 can output, to the generation part 130 described later, the motion data (such as an MPEG file and a TSV file) regarding the face, limbs, and the like of the performer, the data regarding the position and orientation of each portion of the body of the performer, and the voice data (such as an MPEG file) regarding the utterance or the singing uttered by the performer which are generated as described above.

In this way, the sensor part 100 can retrieve a moving image such as an MPEG file and a position (such as coordinates) of the face, limbs, and the like of the performer for each unit time section as data regarding the performer in association with the time code.

According to such an embodiment, for example, with respect to each portion such as the face, limbs, and the like of the performer, the sensor part 100 can retrieve the data including an MPEG file and the like captured for each unit time section and the position (e.g., coordinates) of each portion. Specifically, for each unit time section, for example, the sensor part 100 may include information indicating the position (e.g., coordinates) of a right eye with respect to the right eye and information indicating the position (e.g., coordinates) of an upper lip with respect to the upper lip.

In another embodiment, the sensor part 100 can utilize a technology called Augmented Faces. As the Augmented Faces, those disclosed at https://developers.google.com/ar/develop/java/augmented-faces/can be utilized, and the entire contents thereof are incorporated herein by reference.

Incidentally, the sensor part 100 can further output, to the change amount retrieval part 110 described later, the motion data (such as an MPEG file and a TSV file), which is generated as described above, regarding a plurality of specific portions among the body portions such as the face, limbs, and the like of the performer. Herein, the plurality of specific portions may include any portion of the body, for example, the head, a portion of the face, the shoulder (which may be clothes covering the shoulder), and the limbs. More specifically, the portion of the face may include a forehead, eyebrows, eyelids, cheeks, a nose, ears, lips, a mouth, a tongue, jaws, and the like without being limited thereto.

Although it is described as above that the sensor part 100 detects the motion, facial expression, utterance, and the like of the performer present in the studio room, in addition, the sensor part 100 may detect the motion and facial expression of the supporter present with the performer in the studio room or and the operator and the like of the studio unit 40. In this case, the sensor part 100 may output, to the change amount retrieval part 110 described later, the data (such as an MPEG file and a TSV file) regarding a plurality of specific portions among the body portions such as the face, limbs, and the like of the supporter or the operator.

(2) Change Amount Retrieval Part 110

The change amount retrieval part 110 retrieves the change amount (e.g., displacement amount) of each of the plurality of specific portions of the body of the performer on the basis of the data retrieved by the sensor part 100 and regarding the motion of the body of the performer (which may be the supporter or the operator as described above). Specifically, for example, with respect to a specific portion called a right cheek, the change amount retrieval part 110 can retrieve the change amount of the specific portion called the right cheek between a first unit time section and a second unit time section by taking a difference between the position (e.g., coordinates) retrieved in the first unit time section and the position (e.g., coordinates) retrieved in the second unit time section. With respect to another specific portion, the change amount retrieval part 110 can also retrieve the change amount of the other specific portion in the same manner.

Incidentally, in order to retrieve the change amount of each specific portion, the change amount retrieval part 110 can use a difference between the position (e.g., coordinates) retrieved in an arbitrary unit time section and the position (e.g., coordinates) retrieved in another arbitrary unit time section. Further, the unit time section may be fixed, variable, or a combination thereof.

(3) Determination Part 120

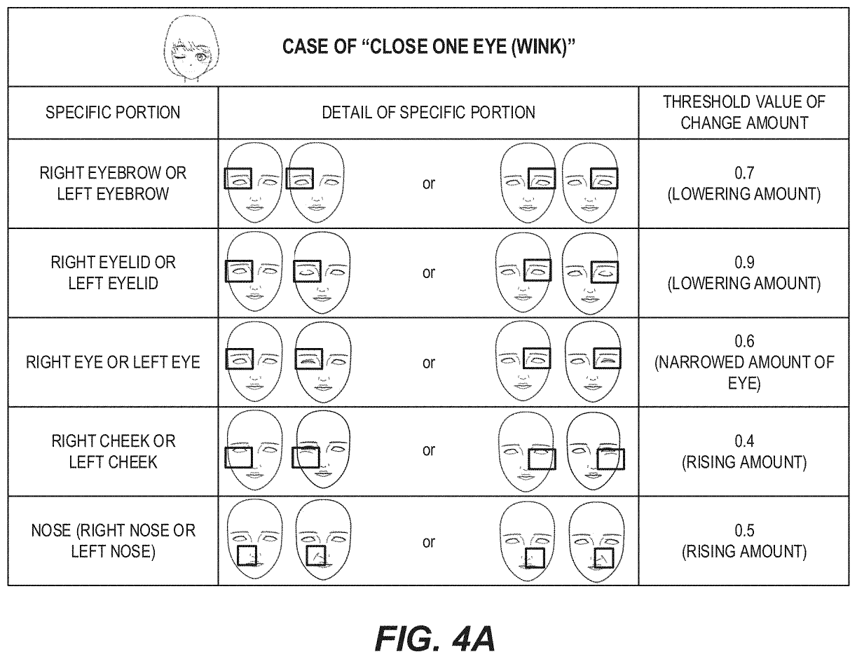

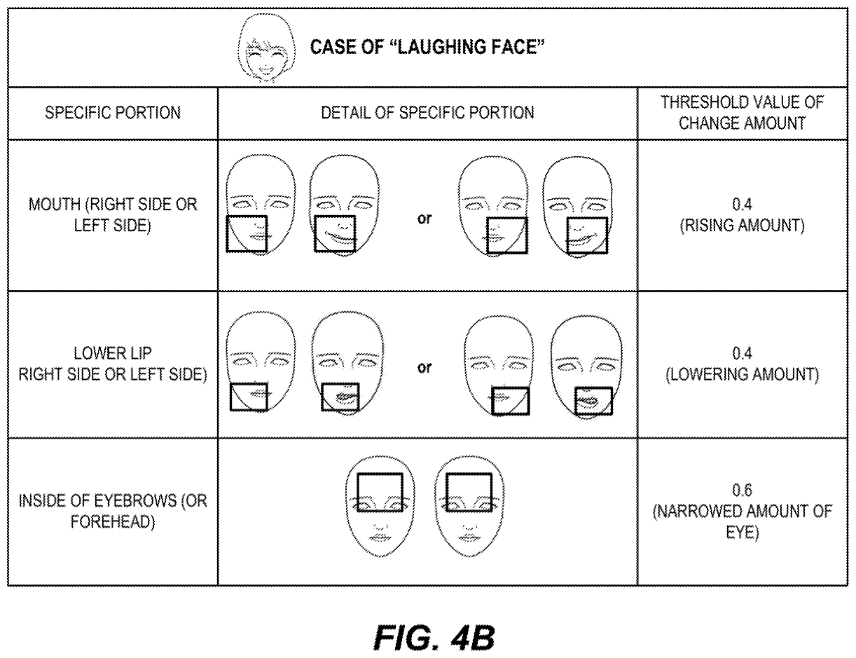

Next, the determination part 120 is described with reference to FIGS. 4A and 4B. FIG. 4A is a diagram illustrating a relationship between a specific portion specified corresponding to a specific facial expression “close one eye (wink)” and the threshold value thereof. FIG. 4B is a diagram illustrating a relationship between a specific portion specified corresponding to a specific facial expression “laughing face” and the threshold value thereof. The determination part 120 may be configured to determine that a specific facial expression or motion (e.g., “close one eye (wink)” or “laughing face”) is formed based on the change amounts retrieved by the change amount retrieval part 110.

In some embodiments, the determination part 120 determines whether or not all the change amounts of one or more specific portions specified in advance among the change amounts of the plurality of specific portions retrieved by the change amount retrieval part 110 exceed respective threshold values and then, in the case of determination of exceeding, determines that the performer or the like forms a specific facial expression. Specifically, as the specific facial expression, the determination part 120 can use facial expressions such as “laughing face”, “close one eye (wink)”, “surprised face”, “sad face”, “angry face”, “bad face”, “embarrassed face”, “close both eyes”, “stick out tongue”, “open mouth wide”, “puff cheeks”, and “open both eyes” without being limited thereto. Further, for example, a motion such as “shake shoulders” or “shake head” may be used in addition to or instead of the specific facial expression. However, regarding these specific facial expressions and specific motions, it may be beneficial for the determination part 120 to determine only the facial expressions (or motions) which the performer (which may be the supporter or the operator as described above) intentionally forms. Therefore, in order to prevent erroneous determination on what the performer does not form intentionally, it may be beneficial to appropriately select those which do not overlap with various performances and the facial expressions during utterance formed by the performer or the like in the studio room.

The determination part 120 specifies in advance the change amounts of one or more specific portions corresponding to each specific facial expression (or specific motion) described above. Specifically, as illustrated in FIG. 4A, for example, in a case where the specific facial expression is “close one eye (wink)”, eyebrows (a right eyebrow or a left eyebrow), eyelids (a right eyelid or a left eyelid), eyes (a right eye or a left eye), cheeks (a right cheek or a left cheek), and a nose (a right part of the nose or a left part of the nose) can be used as an example of the specific portion to retrieve the change amount thereof. More specifically, as an example, the right eyebrow, the right eyelid, the right eye, the right cheek, and the nose can be the specific portions. Further, as illustrated in FIG. 4B, for example, in a case where the specific facial expression is a “laughing face”, a mouth (right side or left side), a lip (a right side or a left side of the lower lip), and the inside of the eyebrows (or a forehead) are used as the specific portions to retrieve the change amount thereof.

As illustrated in FIGS. 4A and 4B, a threshold value is set corresponding to the above-described specific facial expression for each change amount of the specific portion specified in advance. Specifically, for example, in a case where the specific facial expression is “close one eye (wink)”, the threshold value of the change amount (in this case, lowering amount) of the eyebrow is set to 0.7, the threshold value of the change amount (lowering amount) of the eyelid is set to 0.9, the threshold value of the change amount (narrowed amount of eyes) of the eye is set to 0.6, the threshold value of the change amount (rising amount) of the cheek is set to 0.4, and the threshold value of the change amount (rising amount) of the nose is set to 0.5. Similarly, in a case where the specific facial expression is a “laughing face”, the threshold value of the change amount (rising amount) of the mouth is 0.4, the threshold value of the change amount (lowering amount) of the lower lip is 0.4, and the threshold value of the change amount (rising amount) of the inside of the eyebrows is set to 0.1. Each value of these threshold values can be appropriately set via the user interface part 140 as described later. Incidentally, the narrowed amount of the eye is an amount of reduction in the opening amount of the eye, for example, an amount of reduction in a distance between the upper and lower eyelids.

The specific portions corresponding to the specific facial expression can be changed appropriately. Specifically, as illustrated in FIG. 4A, in a case where the specific facial expression is “close one eye (wink)”, five portions of the eyebrows, eyelids, eyes, cheeks, and nose may be specified in advance as the specific portions, or only three portions of the eyebrows, eyelids, and eyes among the five portions may be specified in advance as the specific portions. However, it may be beneficial for the determination part 120 to determine only the facial expressions (or motions) which the performer (which may be the supporter or the operator as described above) intentionally forms. Therefore, in order to prevent erroneous determination on what the performer does not form intentionally, it may be beneficial for the number of specific portions corresponding to the specific facial expression to be large.

In this way, for example, regarding the “close one eye (wink)”, the determination part 120 monitors the change amounts of the eyebrows, eyelids, eyes, cheeks, and nose as the specific portions retrieved by the change amount retrieval part 110 and determines that “close one eye (wink)” is made by the performer (which may be the supporter or the operator as described above) when all the change amounts exceed the respective threshold values described above. Incidentally, in this case, the determination part 120 may determine that “close one eye (wink)” is formed when all the change amounts actually exceed the respective threshold values described above, or the determination part 120 may determine that “close one eye (wink)” is formed under an added condition that a state where all the change amounts actually exceed the respective threshold values described above continues for a predetermined time (for example, one second or two seconds). By adopting the latter aspect, it is possible to efficiently avoid erroneous determination by the determination part 120.

Incidentally, in the case where the above-described determination is made by the determination part 120, the determination part 120 outputs information (e.g., a signal) regarding the determination result (for example, the determination result indicating that the “close one eye (wink)” is formed by the performer) to the generation part 130. In this case, for example, the determination result information output from the determination part 120 to the generation part 130 includes at least one of information indicating the change amount of each specific portion, a cue indicating determination to reflect, on the avatar object, the specific expression corresponding to the specific facial expression or motion formed when the change amounts of the specific portions exceed respective threshold values, and an ID of the specific expression (also referred to as “special expression ID”) as information that requests to reflect the specific expression corresponding to the formed specific facial expression or motion on the avatar object.

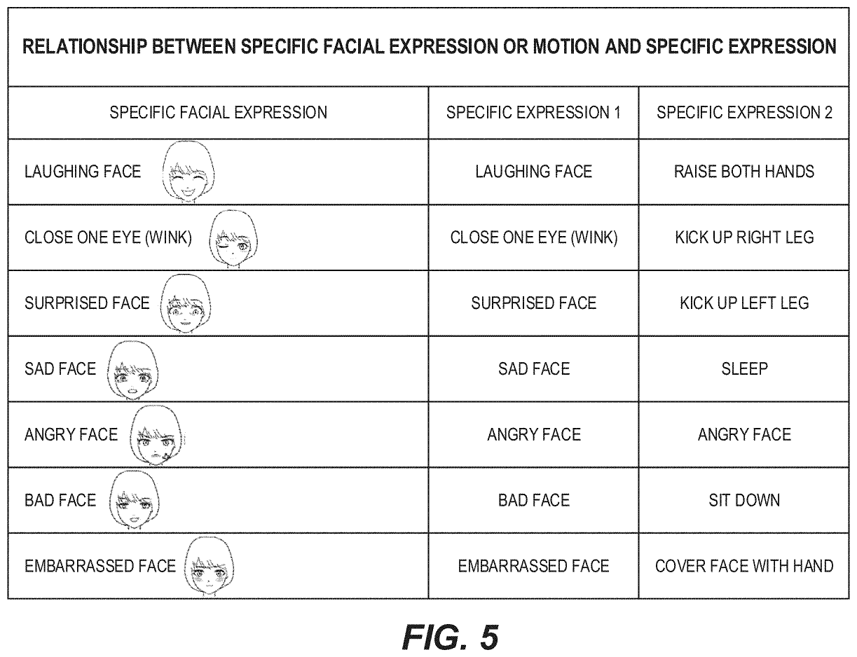

Herein, a relationship between the specific facial expression or motion and the specific expression (e.g., specific motion or facial expression) is described with reference to FIG. 5. FIG. 5 is a diagram illustrating the relationship between the specific facial expression or motion and the specific expression (e.g., specific motion or facial expression).

The relationship between the specific facial expression or motion and the specific expression (specific motion or facial expression) may be appropriately selected from (i) the same relationship, (ii) a similar relationship, and (iii) a completely unrelated relationship. Specifically, for example, as in specific expression 1 in FIG. 5, as a specific expression corresponding to a specific facial expression “close one eye (wink)” and the like, the same “close one eye (wink)” may be used. On the other hand, as shown in specific expression 2 in FIG. 5, an unrelated relationship may be made such that “raise both hands” corresponds to a specific facial expression “laughing face”, “kick up right leg” corresponds to “close one eye (wink)”, and “sleep”, “close one eye”, and the like corresponds to “sad face”. Further, “sad face” and the like may be used corresponding to “laughing face”. Furthermore, a facial expression similar to the “bad face” may be used corresponding to “laughing face”. Furthermore, a cartoon picture or the like may be used as a specific expression in the same relationship, a similar relationship, and a completely unrelated relationship. That is, the specific facial expression can be used as a trigger for reflecting the specific expression on the avatar object.

Incidentally, the relationship between the specific facial expression or motion and the specific expression (e.g., specific motion or facial expression) is appropriately changed via the user interface part 140 described later.

(4) Generation Part 130

The generation part 130 can generate a moving image including an animation of the avatar object corresponding to the performer on the basis of the motion data (such as an MPEG file and a TSV file) regarding the face, limbs, and the like of the performer, the data regarding the position and orientation of each portion of the body of the performer, and the voice data (such as an MPEG file) regarding the utterance or the singing uttered by the performer which are output from the sensor part 100. Regarding the moving image itself of the avatar object, the generation part 130 can also generate a moving image of the avatar object by

using various kinds of information (such as geometry information, bone information, texture information, shader information, and blend shape information) stored in a character data storage part (not illustrated) and causing a rendering unit (not illustrated) to execute rendering.

When the generation part 130 retrieves the above-described determination result information from the determination part 120, the generation part 130 reflects the specific expression corresponding to the determination result information on the moving image of the avatar object generated as described above. Specifically, for example, as an example, when the determination part 120 determines that a specific facial expression or motion “close one eye (wink)” is formed by the performer, and the generation part 130 receives the ID (which may be information regarding the cue described above) of the corresponding specific expression “close one eye (wink)” from the determination part 120, the generation part 130 generates a moving image (or an image) in which the specific expression “close one eye (wink)” is reflected on the avatar object corresponding to the performer.

Incidentally, regardless of the retrieval of the determination result information of the determination part 120, as described above, the generation part 130 generates the moving image (this moving image is referred to as a “first moving image” for convenience) including an animation of the avatar object corresponding to the performer on the basis of the motion data (such as an MPEG file and a TSV file) regarding the face, limbs, and the like of the performer, the data regarding the position and orientation of each portion of the body of the performer, and the voice data (such as an MPEG file) regarding the utterance or the singing uttered by the performer which are output from the sensor part 100. On the other hand, in a case where the generation part 130 retrieves the above-described determination result information from the determination part 120, the generation part 130 generates the moving image (or image) (this moving image is referred to as a “second moving image” for convenience) in which a predetermined specific expression is reflected on the avatar object on the basis of the motion data (such as an MPEG file and a TSV file) regarding the face, limbs, and the like of the performer, the data regarding the position and orientation of each portion of the body of the performer, the voice data (such as an MPEG file) regarding the utterance or the singing uttered by the performer, and the determination result information received from the determination part 120 which are output from the sensor part 100.

(5) User Interface Part 140

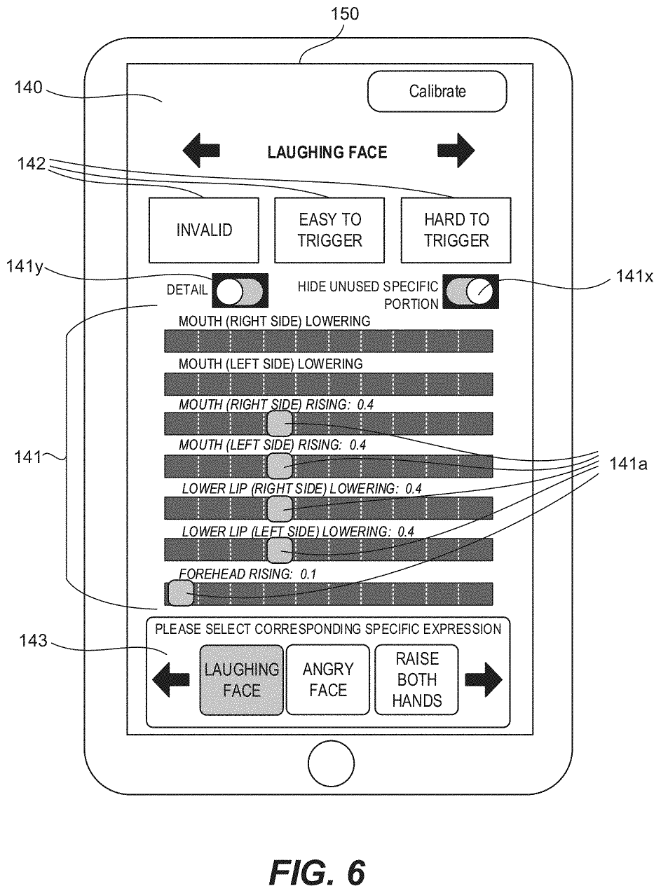

Next, the user interface part 140 is described with reference to FIGS. 6 to 8. FIGS. 6 to 8 are diagrams schematically illustrating an example of the user interface part 140.

The user interface part 140 in the studio unit 40 is displayed on the display part 150, the above-described moving image (or image) is transmitted to the server device 30, various kinds of information regarding the above-described threshold values and the like are input through the operation of the performer or the like, thereby visually sharing various kinds of information with the performer or the like.

For example, as illustrated in FIG. 6, the user interface part 140 can set (e.g., change) the specific facial expression or motion and the threshold value of the specific portion corresponding thereto. Specifically, in the user interface part 140, a slider 141a for each specific portion (for example, in FIG. 6, the right side of the mouth, the left side of the mouth, the right side of the lower lip, the left side of the lower lip, and the forehead, and in FIG. 6, the display mode of these specific portions is expressed in a form in which a font, color, and the like are emphasized) can be adjusted appropriately on the basis of touch operations on the display part 150 to change a threshold value to an arbitrary value from 0 to 1. Incidentally, in FIG. 6, in a case where “laughing face” is set as the specific facial expression, each of the threshold values regarding the right side of the mouth (rising), the left side of the mouth (rising), the right side of the lower lip (lowering), the left side of the lower lip (lowering), and the forehead (rising) which are the specific portions described in FIG. 4B is set to 0.4 or 0.1. However, these threshold values can be changed by operating the slider 141a. This slider 141a is referred to as a first user interface part 141 for convenience. Further, in FIG. 6, the right side of the mouth (lowering) and the left side of the mouth (lowering) are not setting targets of the threshold values, and thus the above-described slider 141a is not displayed in these areas. That is, in setting the threshold values, it is necessary to specify the specific portion corresponding to the specific facial expression or motion to be set and then further specify an aspect (e.g., rising, lowering, and the like) regarding the change amount. Incidentally, as illustrated in FIG. 6, in the user interface part 140, as well as the slider 141a, a dedicated slider 141x may be provided additionally on the right side of the mouth (lowering) and the left side of the mouth (lowering) so that tabs themselves on the right side of the mouth (lowering) and the left side of the mouth (lowering) are not displayed on the user interface part 140 (e.g., display part 150). Alternatively, the user interface part 140 may be provided additionally with a dedicated slider 141y which enables selection that the specific portion and the threshold value or the slider 141a corresponding to the specific portion are not displayed on the screen. The sliders 141x and 141y are an example of an operation part that switches the display mode.

Incidentally, as described above, the specific portion corresponding to the specific facial expression can be also changed appropriately by the user interface part 140 (e.g., first user interface part 141). For example, as illustrated in FIG. 6, in a case where the specific facial expression is “laughing face”, and the specific portions are changed from five portions of the right side of the mouth, the left side of the mouth, the right side of the lower lip, the left side of the lower lip, and the forehead to four portions without the forehead, the specific portion corresponding to the “laughing face” can be changed by interacting with (e.g., performing clicking or tapping of) the tab of “forehead rising” or the like.

The user interface part 140 may be configured to automatically change each of the threshold values of the specific portions corresponding to the specific facial expression to a preset predetermined value without operating the slider 141a. Specifically, for example, as an example, a configuration may be adopted in which two modes are prepared in advance, and when any one of the two modes is selected on the basis of the selection operation in the user interface part 140, the threshold values are automatically changed to the threshold values (e.g., predetermined values) corresponding to the selected mode. In this case, in FIG. 6, two modes of “easy to trigger” and “hard to trigger” are prepared, and the performer or the like can select any one of the modes of “easy to trigger” and “hard to trigger” by performing a touch operation on the user interface part 140. Incidentally, the tabs corresponding to “easy to trigger” and “hard to trigger” in FIG. 6 are referred to as a second user interface part 142 for convenience. In the second user interface part 142, each threshold value can be regarded as a preset set menu.

Incidentally, in the above-described mode of “easy to trigger”, each threshold value is set to a low value (for example, each of the threshold values of the right side of the mouth, the left side of the mouth, the right side of the lower lip, and the left side of the lower lip which are the specific portions in the specific facial expression “laughing face” is less than 0.4, and the threshold value of the forehead is less than 0.1) overall. Accordingly, it is possible to increase a frequency with which the determination part 120 determines that the “laughing face” is formed by the performer or the like or to facilitate the determination by the determination part 120. On the other hand, in the mode of “hard to trigger”, each threshold value is set to a high value (for example, each of the threshold values of the right side of the mouth, the left side of the mouth, the right side of the lower lip, and the left side of the lower lip which are the specific portions in the specific facial expression “laughing face” is greater than 0.4, and the threshold value of the forehead is greater than 0.1) overall. Accordingly, it is possible to decrease a frequency with which the determination part 120 determines that the “laughing face” is formed by the performer or the like or to limit the determination by the determination part 120.

Incidentally, each preset threshold value (each predetermined value) in the mode of “easy to trigger” may be a value different for each specific portion or may be the same value for at least two specific portions. Specifically, for example, each of the threshold values of the right side of the mouth, the left side of the mouth, the right side of the lower lip, and the left side of the lower lip which are the specific portions in the specific facial expression “laughing face” may be 0.2, and the threshold value of the forehead may be 0.05. Alternatively, the threshold value of the right side of the mouth may be 0.1, the threshold value of the left side of the mouth may be 0.3, the threshold value of the right side of the lower lip may be 0.01, the threshold value of the left side of the lower lip may be 0.2, and the threshold value of the forehead may be 0.05. Further, these threshold values are set to be less than default values at a time when the specific application is installed in the studio unit 40.

Similarly, each preset threshold value (e.g., each predetermined value) in the mode of “hard to trigger” also may be a value different for each specific portion or may be the same value for at least two specific portions. Specifically, for example, each of the threshold values of the right side of the mouth, the left side of the mouth, the right side of the lower lip, and the left side of the lower lip which are the specific portions in the specific facial expression “laughing face” may be 0.7, and the threshold value of the forehead may be 0.5. Alternatively, the threshold value of the right side of the mouth may be 0.7, the threshold value of the left side of the mouth may be 0.8, the threshold value of the right side of the lower lip may be 0.6, the threshold value of the left side of the lower lip may be 0.9, and the threshold value of the forehead may be 0.3. Alternatively, in a case where the mode “easy to trigger” is changed to the mode “hard to trigger” (or vice versa), the predetermined values in the mode “easy to trigger” (or the predetermined values in the mode “hard to trigger”) are used as it is for the threshold values of some specific portions (for example, the left side of the lower lip and the forehead) of the specific portions of the right side of the mouth, the left side of the mouth, the right side of the lower lip, the left side of the lower lip, and the forehead.

Incidentally, as for the second user interface part 142, in the above description with reference to FIG. 6, two modes (e.g., tabs) of “easy to trigger” and “hard to trigger” are provided. However, the present invention is not limited to this, and for example, three (e.g., three types) or more modes (e.g., tabs) may be provided. For example, three modes of “normal”, “easy to trigger”, and “very easy to trigger” may be provided, and four modes of “normal”, “easy to trigger”, “very easy to trigger”, and “extremely easy to trigger” may be provided. In these cases, these threshold values may be set to be less than default values at a time when the specific application is installed in the studio unit 40 or may be set greater than the default values.

In the second user interface part 142, a tab for invalidating the operation of the second user interface part 142 may be provided. In FIG. 6, a tab “invalid” is provided. When this tab is touch-operated, the performer or the like appropriately sets the threshold value by using only the first user interface part 141.

The user interface part 140 is provided additionally with a tab for setting back all the threshold values set in the first user interface part 141 or the second user interface part 142 to the above-described default values.

The reason for appropriately setting (e.g., changing) each threshold value in this way is that the performers or the like who form specific facial expressions have individual differences. In some cases, a certain person is easy to form a specific expression (or is likely to be determined by the determination part 120 to form a specific expression) while another person is difficult to form the specific expression. Therefore, it may be beneficial to reset appropriately (e.g., every time the person to be determined is changed) each threshold value so that the determination part 120 can accurately determine for any person that the specific facial expression is formed.

It may be beneficial for the threshold value (e.g., change amount) to be initialized every time the person regarding the performer or the like as the determination target changes. As illustrated in FIG. 6, when a case where there is no change amount of the specific portion is set as a reference 0, and the maximum change amount of the specific portion is 1, a threshold value in an arbitrary specific portion is set appropriately between 0 and 1. Then, the reference 0 to 1 of a certain person X and the reference 0 to 1 of another person Y are different in their ranges (for example, the maximum change amount of the person Y may be equivalent to only 0.5 in the person X in light of 0 to 1 of the person X). Therefore, in order to express the change amount of the specific portion in all the persons with 0 to 1, it may be beneficial to initially set the width of the change amount (e.g., multiply by a predetermined magnification). In FIG. 6, the initial setting is executed by touching the “Calibrate” tab.

The user interface part 140 can set each threshold value in both the first user interface part 141 and the second user interface part 142 as described above. With this configuration, for example, the performer or the like who wants to try moving image distribution regardless of fine threshold-value setting or early can use the second user interface part 142. On the other hand, a performer or the like concerned with fine threshold setting can also customize his/her own threshold value by operating the slider 141a of the first user interface part 141 corresponding to each threshold value. By using such a user interface part 140, each threshold value can be appropriately set according to the preference of the performer or the like, which is convenient for the performer or the like. Further, for example, it is possible to operate the slider 141a of the first user interface part 141 after setting a predetermined mode (for example, a mode of “easy to trigger”) by using the second user interface part 142. Thus, it is possible to improve the variation of the use method of the user interface part 140.

The user interface part 140 can appropriately set or change various values and information other than the above-described threshold value. For example, in a case where the above-described determination operation by the determination part 120 has a condition that a state where all the change amounts of the specific portions corresponding to the specific facial expression actually exceed respective threshold values continues for a predetermined time (for example, one second or two seconds), the user interface part 140 may additionally include a user interface (for example, a slider although not illustrated in FIG. 6) for setting the predetermined time. Further, also for a certain time (for example, five seconds) for reflecting the specific expression corresponding to the specific facial expression determined by the determination part 120 on the moving image (or the image) of the avatar object corresponding to the performer, the user interface part 140 (for example, another slider different from the sliders 141x and 141y although not illustrated in FIG. 6) can be used to set (e.g., change) to an appropriate value.

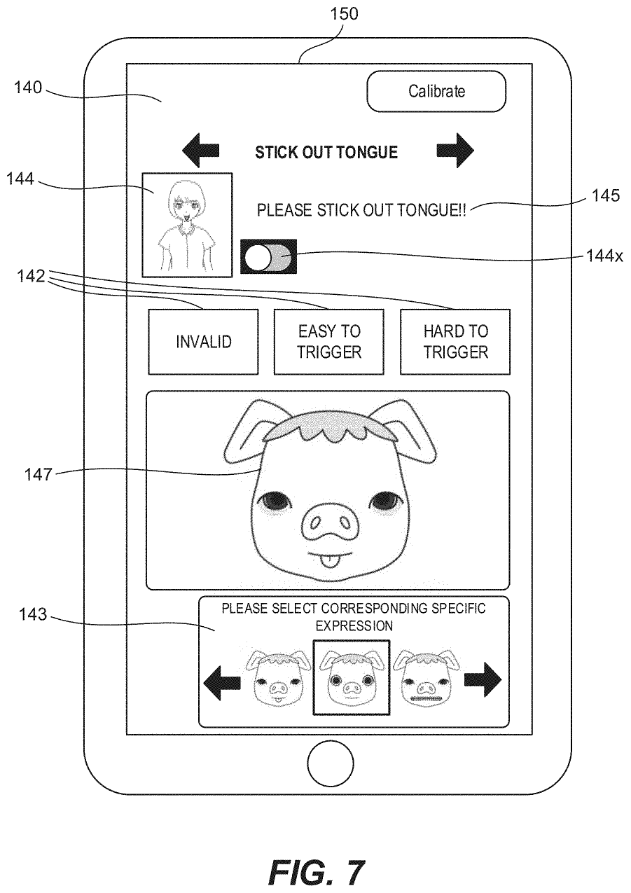

As illustrated in FIG. 6, the user interface part 140 may include a third user interface part 143 capable of setting or changing the above-described relationship between the specific facial expression or motion and the specific expression (e.g., specific motion or facial expression). With respect to a “laughing face” as a specific facial expression, the third user interface part 143 can select a specific expression to be reflected on the avatar object from a plurality of candidates such as a “laughing face” identical to the “laughing face” as the specific expression and a completely unrelated “angry face” and “raise both hands” by touch operation (or flick operation) (an aspect in which “laughing face” is selected as the specific expression is illustrated for convenience in FIG. 6). Incidentally, as illustrated in FIG. 7 described later, the image of the avatar object in which a specific expression as a candidate is reflected may be used as the specific expression candidate.

At the time of setting or changing any of a specific facial expression or motion, a specific portion corresponding to the specific facial expression or motion, each threshold value corresponding to the specific portion, a correspondence relationship between the specific facial expression or motion and the specific expression, a predetermined time, and a certain time, image information 144 and character information 145 regarding the specific facial expression or motion are included in the user interface part 140. Specifically, as illustrated in FIG. 7, for example, when “stick out tongue” is set as the specific facial expression, in order to easily inform a setting target person of the face of “stick out tongue” (e.g., to instruct the setting object person), the image information 144 as an illustration of “stick out tongue” and the character information of “stick out tongue!!” are included in the user interface part 140. Accordingly, the performer or the like who is a setting target person can set or change each information while viewing the image information 144 and the character information 145 (only one of which may be displayed). Incidentally, the user interface part 140 (e.g., display part 150) may be provided with a dedicated slider 144x capable of selecting display or non-display of the image information 144 (or the character information 145).

At the time of setting or changing any of a specific facial expression or motion, a specific portion corresponding to the specific facial expression or motion, each threshold value corresponding to the specific portion, a correspondence relationship between the specific facial expression or motion and the specific expression, a predetermined time, and a certain time, in a case where the determination part 120 determines that the specific facial expression or motion is formed, a first test moving image 147 (or the first test image 147) in which the same specific expression as the specific facial expression or motion is reflected on the avatar object is included in the user interface part 140. Specifically, as illustrated in FIG. 7, as an example, the performer or the like forms the facial expression “stick out tongue” as the specific facial expression in front of the sensor part 100 on the basis of the image information 144 or the character information 145 described above. As a result, when the determination part 120 determines that the specific expression “stick out tongue” is formed, the first test moving image 147 (or first test image 147) which is the avatar object reflecting the specific expression “stick out tongue” is displayed. Accordingly, the performer or the like can easily recognize an image regarding what kind of avatar object image or moving image is generated for the specific facial expression or motion formed by the performer or the like.

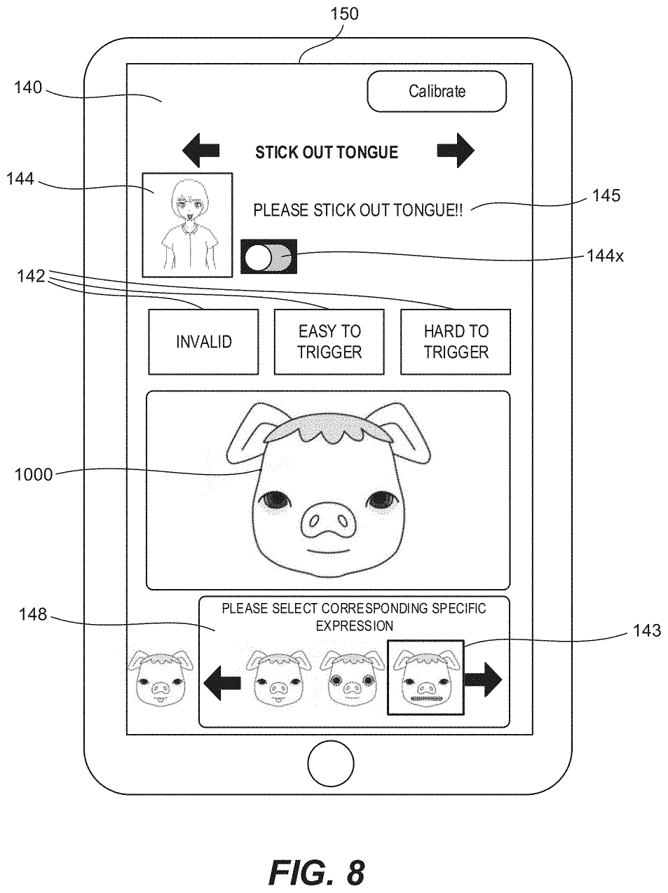

At the time of setting or changing any of a specific facial expression or motion, a specific portion corresponding to the specific facial expression or motion, each threshold value corresponding to the specific portion, a correspondence relationship between the specific facial expression or motion and the specific expression, a predetermined time, and a certain time, in a case where the determination part 120 determines that a specific facial expression or motion is formed, even after the above-described certain time has elapsed, a second test moving image 148 (or a second test image 148) which is the same moving image (or image) as the above-described first test moving image 147 (or first test image 147) and has a smaller size than the first test moving image 147 (or first test image 147) is included over a specific time in the user interface part 140. Specifically, as an example, as a result of the facial expression “stick out tongue” of the performer or the like, the determination part 120 determines that the specific facial expression “stick out tongue” is formed, and the first test moving image 147 (or first test image 147) is displayed as illustrated in FIG. 7. Thereafter, when the determination is canceled, and a certain time has elapsed, as illustrated in FIG. 8, any specific expression is not reflected on an avatar object 1000. However, as illustrated in FIG. 8, when a moving image (or an image) having the same content as the first test moving image 147 (or first test image 147) formed immediately before is included as the second test moving image 148 (or second test image 148) in the user interface part 140, the performer or the like can slowly set, for example, the correspondence relationship between the specific facial expression or motion and the specific expression over time while viewing the related image. The specific time may be the same as the certain time or may be different from the certain time.

As described above, the user interface part 140 enables various kinds of information to be set by the performers and the like, and various kinds of information can be visually shared with the performers or the like. Further, various kinds of information such as a specific facial expression or motion, a specific portion corresponding to the specific facial expression or motion, each threshold value corresponding to the specific portion, a correspondence relationship between the specific facial expression or motion and the specific expression, a predetermined time, and a certain time may be set or changed before (or after) the moving image distribution or during the distribution of the moving image (or image). Further, in one example of the user interface part 140 relating to FIGS. 6 to 8, the information may be displayed on separate pages while being linked in the display part 150, or all the information may be displayed on the same page so that the performer or the like can visually recognize the information by scrolling in the vertical direction or the horizontal direction in the display part 150. Further, in the user interface part 140, the various information illustrated in FIGS. 6 to 8 is not necessarily displayed in the arrangement and combination as illustrated in FIGS. 6 to 8. For example, instead of a part of the information illustrated in FIG. 6, a part of the information illustrated in FIG. 7 or 8 may be displayed in the same page.

(6) Display Part 150

The display part 150 can display the moving image generated by the generation part 130 or the screen related to the user interface part 140 on the display (touch panel) of the studio unit 40, the display connected to the studio unit 40, or the like. The display part 150 can sequentially display the moving images generated by the generation part 130 or can display the moving images stored in the storage part 160 on the display or the like according to the instruction from the performer or the like.

(7) Storage Part 160

The storage part 160 can store the moving image (or the image) generated by the generation part 130. Further, the storage part 160 can also store the above-described threshold value. Specifically, the storage part 160 can store a predetermined default value at the time when a specific application is installed or can store each threshold value set by the user interface part 140.

(8) Communication Part 170

The communication part 170 can transmit the moving image (or the image) generated by the generation part 130 (and further stored in the storage part 160) to the server device 30 via the communication network 10.

The operation of each part described above can be executed when a specific application (for example, an application for moving image distribution) installed in the studio unit 40 is executed by the studio unit 40. Alternatively, the operation of each unit described above can be executed by the studio unit 40 when the browser installed in the studio unit 40 accesses the website provided by the server device 30. Incidentally, as described in the above-described “first aspect”, instead of a configuration in which the studio unit 40 is provided with the generation part 130, and the above-described moving image (e.g., the first moving image and the second moving image) is generated by the generation part 130, a rendering system configuration may be adopted in which the generation part 130 is arranged in the server device 30, the studio unit 40 transmits data regarding the body of the performer or the like and data (e.g., including the information of the determination result by the determination part 120) regarding the change amount of each of a plurality of specific portions of the body of the performer or the like based on the data through the communication part 170 to the server device 30, and the server device 30 generates the moving image (e.g., the first moving image and the second moving image) in which a predetermined specific expression is reflected on the avatar object corresponding to the performer in accordance with the data received from the studio unit 40. Alternatively, a rendering system configuration may be adopted in which the studio unit 40 transmits data regarding the body of the performer or the like and data (e.g., including the information of the determination result by the determination part 120) regarding the change amount of each of a plurality of specific portions of the body of the performer or the like based on the data through the communication part 170 to the server device 30, the server device 30 transmits the data received from the studio unit 40 to the terminal device 20, and the generation part 130 provided in the terminal device 20 generates the moving image (e.g., the first moving image and the second moving image) in which a predetermined specific expression is reflected on the avatar object corresponding to the performer in accordance with the data received from the server device 30.

3-2. Function of Terminal Device 20

A specific example of the function of the terminal device 20 is described with reference to FIG. 3. As the function of the terminal device 20, for example, the function of the studio unit 40 described above can be used. Therefore, the reference numerals for the components included in each terminal device 20 are shown in parentheses in FIG. 3.

In the above-described “second aspect”, the terminal device 20 (for example, the terminal device 20A in FIG. 1) may have a sensor part 200 to a communication part 270 which are the same as the sensor part 100 to the communication part 170 described in relation to the studio unit 40, respectively. Further, when a specific application (for example, an application for moving image distribution) installed in the terminal device 20 is executed by the terminal device 20, the operation of each part described above can be executed by the terminal device 20. Incidentally, as described in the above-described “second aspect”, instead of a configuration in which the terminal device 20 is provided with a generation part 230, and the above-described moving image is generated by the generation part 230, a configuration may be adopted in which the generation part 230 is arranged in the server device 30, the terminal device 20 transmits data regarding the body of the performer or the like and data (e.g., including the information of the determination result by a determination part 220) regarding the change amount of each of a plurality of specific portions of the body of the performer or the like based on the data through the communication part 270 to the server device 30, and the server device 30 generates the moving image (e.g., the first moving image and the second moving image) in which a predetermined specific expression is reflected on the avatar object corresponding to the performer in accordance with the data received from the terminal device 20. Alternatively, a configuration may be adopted in which the terminal device 20 transmits data regarding the body of the performer or the like and data (e.g., including the information of the determination result by the determination part 220) regarding the change amount of each of a plurality of specific portions of the body of the performer or the like based on the data through the communication part 270 to the server device 30, the server device 30 transmits the data received from the terminal device 20 to another terminal device 20 (for example, a terminal device 20C in FIG. 1), and the generation part 230 provided in the other terminal device 20 generates the moving image (e.g., the first moving image and the second moving image) in which a predetermined specific expression is reflected on the avatar object corresponding to the performer in accordance with the data received from the server device 30.

On the other hand, for example, in the “first aspect” and the “third aspect”, the terminal device 20 includes at least only the communication part 270 among the sensor part 200 to the communication part 270 so that the moving image (or the image) generated by the generation part 130 or 330 provided in the studio unit 40 or the server device 30 can be received via the communication network 10. In this case, by executing a specific application installed (for example, an application for watching moving images) and transmitting a signal (e.g., request signal) to request distribution of a desired moving image to the server device 30, the terminal device 20 can receive the desired moving image from the server device 30 responding to this signal via the specific application.

3-3. Function of Server Device 30

A specific example of the function of the server device 30 is described with reference to FIG. 3. As the function of the server device 30, for example, the function of the studio unit 40 described above can be used. Therefore, the reference numerals for the components included in the server device 30 are shown in parentheses in FIG. 3.

In the above-described “third aspect”, the server device 30 may have a sensor part 300 to a communication part 370 which are the same as the sensor part 100 to the communication part 170 described in relation to the studio unit 40, respectively. Further, when a specific application (for example, an application for moving image distribution) installed in the server device 30 is executed by the server device 30, the operation of each part described above can be executed. Incidentally, as described in the above-described “third aspect”, instead of a configuration in which the server device 30 is provided with a generation part 330, and the above-described moving image is generated by the generation part 330, a configuration may be adopted in which the generation part 330 is arranged in the terminal device 20, the server device 30 transmits data regarding the body of the performer or the like and data (e.g., including the information of the determination result by a determination part 320) regarding the change amount of each of a plurality of specific portions of the body of the performer or the like based on the data through the communication part 370 to the terminal device 20, and the terminal device 20 generates the moving image (e.g., the first moving image and the second moving image) in which a predetermined specific expression is reflected on the avatar object corresponding to the performer in accordance with the data received from the server device 30.

4. Overall Operation of Communication System 1

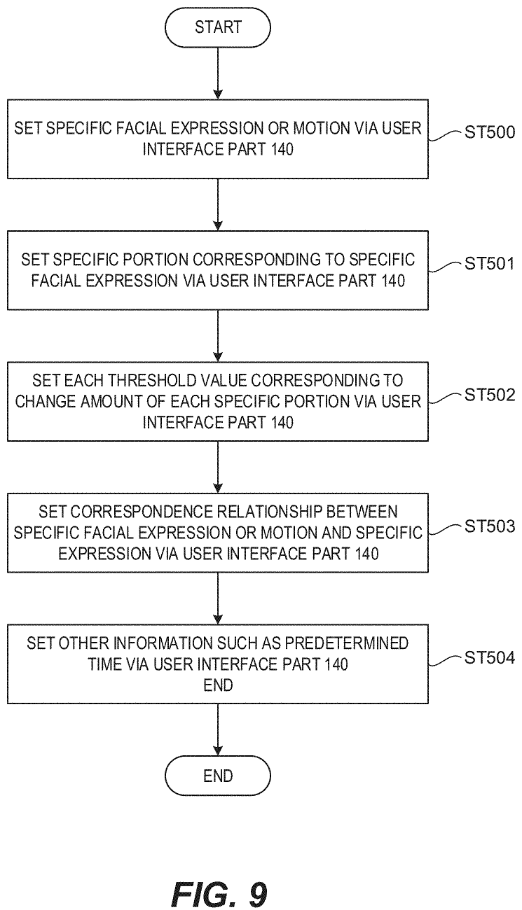

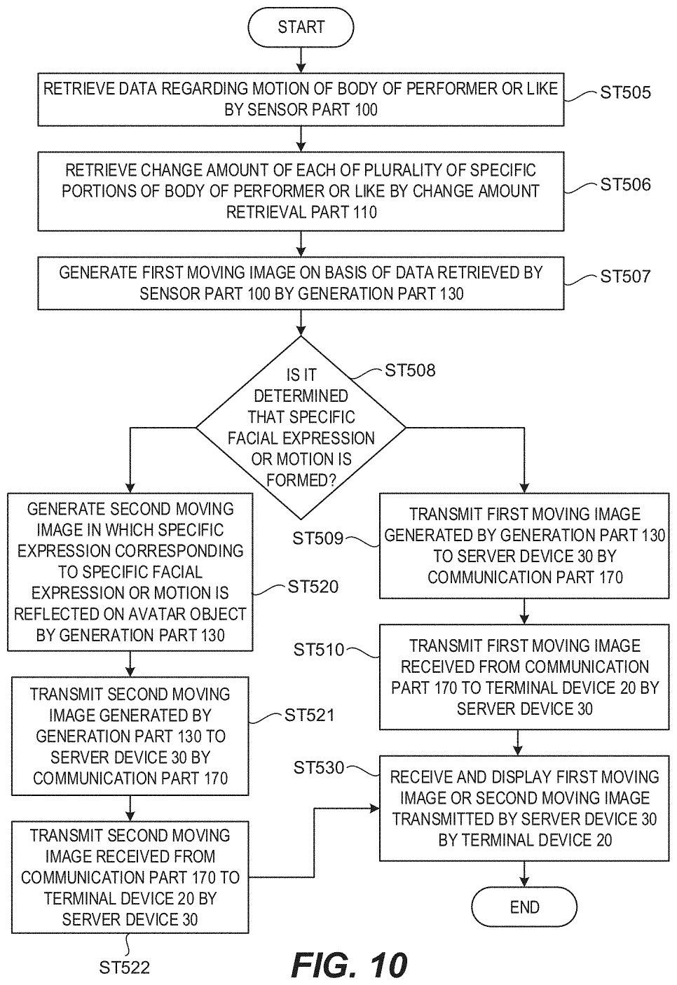

Next, the overall operation performed in the communication system 1 having the above configuration is described with reference to FIGS. 9 and 10. FIGS. 9 and 10 are flowcharts illustrating an example of a part of the operation performed in the communication system 1 illustrated in FIG. 1. Incidentally, the flow chart illustrated in FIG. 10 shows the above-described “first aspect” as an example.

First, in step (hereinafter referred to as “ST”) 500, the performer or the like (e.g., including the supporter or the operator as described above) sets a specific facial expression or motion via the user interface part 140 of the studio unit 40 as described above. For example, facial expressions such as “laughing face”, “close one eye (wink)”, “surprised face”, “sad face”, “angry face”, “bad face”, “embarrassed face”, “close both eyes”, “stick out tongue”, “open mouth wide”, “puff cheeks”, and “open both eyes” and a motion such as “shake shoulders” or “shake head” can be set as the specific facial expression or motion without being limited thereto.

Next, in ST501, as described above with reference to FIG. 6, the performer or the like sets a specific portion (such as eyebrows, eyelids, eyes, cheeks, nose, mouth, and lips) of the body of the performer or the like corresponding to each specific facial expression (such as “close one eye (wink)” and “laughing face”) via the user interface part 140 (e.g., first user interface part 141) of the studio unit 40.

Next, in ST502, as described above with reference to FIG. 6, the performer or the like sets each threshold value corresponding to the change amount of each specific portion set in ST501 via the user interface part 140 of the studio unit 40. In this case, each threshold value may be set to an arbitrary value for each specific portion by using the first user interface part 141 as described above, or each threshold value may be set to a predetermined value by selecting a predetermined mode (for example, a mode of “easy to trigger”) by using the second user interface part 142. Further, the threshold value may be customized using the first user interface part 141 after selecting the predetermined mode in the second user interface part 142.

Next, in ST503, as described above with reference to FIGS. 5 to 8, the performer or the like sets the correspondence relationship between the specific facial expression or motion and the specific expression set in ST500 via the user interface part 140 of the studio unit 40. In this case, the correspondence relationship is set by using the third user interface part 143 as described above.

Next, in ST504, the performer or the like can set the predetermined time or the certain time described above to an appropriate value via the user interface part 140 of the studio unit 40.

ST500 to ST504 illustrated in FIG. 9 can be regarded as a setting operation in the overall operation of the communication system 1. Further, ST500 to ST504 are not necessarily limited to the order of FIG. 9, and for example, the order of ST502 and ST503 may be reversed, or the order of ST501 and ST503 may be reversed. Further, in the case where only one of the values is changed after the setting operation in ST500 to ST504 is executed (or after the operation of generating the moving image illustrated in FIG. 10 is executed), only some steps in ST500 to ST504 may be performed. Specifically, in a case where the setting operation in ST500 to ST504 is executed, and then it is desired to change only the threshold value, only ST502 needs to be executed.

As described above, when the setting operation illustrated in FIG. 9 is completed, next, the operation of generating the moving image illustrated in FIG. 10 can be executed.

When a request (e.g., operation) related to moving image generation is executed by the performer or the like via the user interface part 140, first, in ST505, the sensor part 100 of the studio unit 40 retrieves the data regarding the motion of the body of the performer or the like as described above.

Next, in ST506, the change amount retrieval part 110 of the studio unit 40 retrieves the change amount (e.g., displacement amount) of each of the plurality of specific portions of the body of the performer or the like on the basis of the data retrieved by the sensor part 100 and regarding the motion of the body of the performer or the like.

Next, in ST507, the generation part 130 of the studio unit 40 generates the above-described first moving image on the basis of various kinds of information retrieved by the sensor part 100.

Next, in ST508, the determination part 120 of the studio unit 40 monitors whether or not all the change amounts of the specific portions set in ST501 exceed the respective threshold values set in ST502. Then, in the case of “exceeding”, the determination part 120 determines that the specific facial expression or motion set in ST500 by the performer or the like is formed, and the process proceeds to ST520. On the other hand, in ST508, in the case of “not exceeding”, the process proceeds to ST509.

Next, in ST508, in the case of “not exceeding”, in ST509, the communication part 170 of the studio unit 40 transmits the first moving image generated by the generation part 130 in ST507 to the server device 30. Thereafter, in ST510, the first moving image transmitted from the communication part 170 to the server device 30 in ST509 is transmitted to the terminal device 20 by the server device 30. Then, the terminal device 20 which receives the first moving image transmitted by the server device 30 causes a display part 250 to display the first moving image in ST530. In this way, a series of steps in the case of “not exceeding” in ST508 is completed.

On the other hand, in the case of “exceeding” in ST508, in ST520, the generation part 130 of the studio unit 40 retrieves the information of the determination result indicating that a specific facial expression (or a motion) is formed from the determination part 120 and generates the second moving image in which the specific expression corresponding to the specific facial expression or motion is reflected on the avatar object. Incidentally, at this time, the generation part 130 can reflect the specific expression corresponding to the specific facial expression or motion on the avatar object with reference to the setting in ST503.

Then, in ST521, the communication part 170 transmits the second moving image generated in ST520 to the server device 30. Then, the second moving image transmitted by the communication part 170 is transmitted to the terminal device 20 by the server device 30 in ST522. Then, the terminal device 20 which receives the second moving image transmitted by the server device 30 causes a display part 250 to display the second moving image in ST530. In this way, a series of steps in the case of “exceeding” in ST508 is completed.

When a request (e.g., operation) related to moving image generation (e.g., moving image distribution) is executed via the user interface part 140, processing regarding a series of steps of moving image generation (e.g., moving image distribution) illustrated in FIG. 10 is repeatedly executed. That is, for example, in a case where while it is determined that one specific facial expression or motion is formed by a performer or the like, and the processing regarding the series of steps illustrated in FIG. 10 (for convenience, in this paragraph, referred to as first processing) is executed, the performer or the like determines that another specific facial expression or motion is formed, other processing regarding the series of steps illustrated in FIG. 10 is executed so as to follow the first processing. Thus, in the avatar object, the specific expression corresponding to the specific facial expression or motion formed by the performer or the like is reflected accurately as intended by the performer or the like in real time without a malfunction.

Incidentally, in FIGS. 9 and 10, the “first aspect” is described as an example as above, but also in the “second aspect” and the “third aspect”, basically, a series of steps is similar to those in FIGS. 9 and 10. That is, the sensor part 100 to the communication part 170 in FIGS. 9 and 10 are replaced with the sensor part 200 to the communication part 270 or the sensor part 300 to the communication part 370.

As described above, according to various embodiments, there can be provided a computer program, a server device, and a method in which a performer or the like can easily and accurately cause an avatar object to express a desired facial expression or motion. More specifically, according to various embodiments, even while speaking, only by forming a specific expression, the performer or the like can accurately and easily generate the moving image in which the specific expression (e.g., desired facial expression or motion) is reflected on the avatar object without erroneous operation or malfunction compared with a conventional one. Further, the performer or the like can set (e.g., change) a specific facial expression, motion, or the like as described above while holding the terminal device 20 with a hand and directly distribute the above-described various moving images from the terminal device 20 as they are. Furthermore, at the time of moving image distribution, the terminal device 20 held by the performer or the like can capture a change (e.g., a change in face and body) in the performer or the like at any time and cause the specific expression to be reflected on the avatar object according to the change.

5. Modification

In the embodiment described above, an aspect is assumed in which the performer or the like forms a specific facial expression or motion by himself/herself while operating the user interface part 140. However, the present invention is not limited to this, and for example, an aspect may be assumed in which the performer or the like forms a specific facial expression or motion while a supporter or an operator operates the user interface part 140. In this case, the supporter or the operator can set the threshold value or the like while checking the user interface part 140 as illustrated in FIGS. 6 to 8. Further, at the same time, the sensor part 100 detects the motion, facial expression, utterance (e.g., including singing), and the like of the performer, and when it is determined that the performer forms a specific facial expression or motion, the image or moving image of the avatar object reflecting the specific expression is displayed on the user interface part 140 as illustrated in FIG. 7.

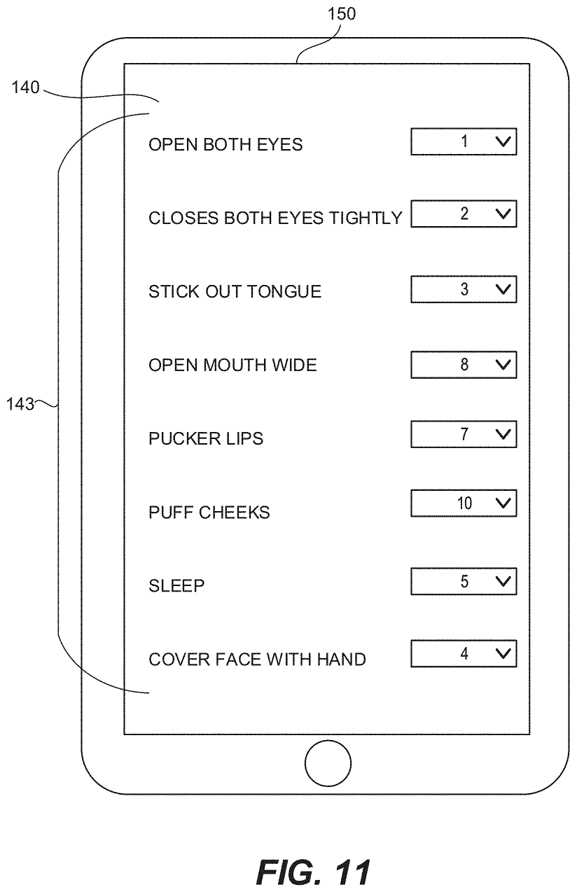

The third user interface part 143 is described above with reference to FIGS. 6 to 8. However, as another embodiment, the one illustrated in FIG. 11 may be used. FIG. 11 is a diagram illustrating a modification of the third user interface part 143. In this case, first, an arbitrary management number is set to each specific facial expression or motion formed by the performer or the like at the time of ST500 in FIG. 9. For example, management number “1” is set to a specific facial expression of “open both eyes”, management number “2” is set to a specific facial expression of “closes both eyes tightly”, management number “3” is set to a specific facial expression of “stick out tongue”, management number “4” is set to a specific facial expression of “open mouth wide”, management number “5” is set to a specific facial expression of “puff cheeks”, management number “6” is set to a specific facial expression of “laughing face”, management number “7” is set to a specific facial expression of “close one eye (wink)”, management number “8” is set to a specific facial expression of “surprised face”, management number “9” is set to a specific motion of “shake shoulders”, and management number “10” is set to a specific motion of “shake head”.

Next, the performer or the like can select the specific facial expression or motion corresponding to the specific expression on the basis of the above-described management number through the third user interface part 143. For example, as illustrated in FIG. 11, when the management number “1” is selected for the specific expression of “open both eyes”, the specific expression “open both eyes” corresponding to the specific facial expression “open both eyes” is reflected on the avatar object. Further, for example, when the management number “2” is selected for the specific expression of “open both eyes”, the specific expression “open both eyes” corresponding to the specific facial expression “closes both eyes tightly” is reflected on the avatar object. Furthermore, for example, as illustrated in FIG. 11, when the management number “8” is selected for the specific expression “open mouth wide”, the specific expression “open mouth wide” corresponding to the specific facial expression “surprised face” is reflected on the avatar object. As described above, when various specific facial expressions or motions are managed with the management numbers, the performer or the like can more easily set or change the correspondence relationship between the specific facial expression or motion and the specific expression.

Incidentally, in this case, the specific facial expression or motion and the management number associated therewith are stored in the storage part 160 (or a storage part 260 or a storage part 360) together with the correspondence relationship. Further, the third user interface part 143 illustrated in FIG. 11 may be displayed as a separate page while linking to FIGS. 6 to 8 or may be displayed in the same page as FIGS. 6 to 8 so as to be visually recognized by scrolling in the vertical direction or the horizontal direction in the display part 150.

For example, in a case where a specific facial expression and a management number are stored in the storage part 160 in association with each other, when the determination part 120 determines that a specific facial expression or motion is formed by the performer or the like, the determination part outputs the management number corresponding to the specific facial expression or motion. The generation part 130 may generate the second moving image in which the specific expression corresponding to the specific facial expression or motion is reflected on the avatar object on the basis of the output management number and the preset correspondence relationship between the management number (e.g., specific facial expression or motion) and the specific expression.

6. Various Aspects

A computer program according to a first aspect may “cause one or more processors to execute: retrieving a change amount of each of a plurality of specific portions of a body on the basis of data regarding a motion of the body retrieved by a sensor; determining that a specific facial expression or motion is formed in a case where all change amounts of one or more specific portions specified in advance among the change amounts of the plurality of specific portions exceed respective threshold values; and generating an image or a moving image in which a specific expression corresponding to the determined specific facial expression or motion is reflected on an avatar object corresponding to a performer”.

In a second aspect, in the computer program according to the first aspect, “the specific expression includes a specific motion or facial expression”.

In a third aspect, in the computer program according to the first or second aspect, “the body is a body of the performer”.

In a fourth aspect, in the computer program according to any one of the first to third aspects, “the processor determines that the specific facial expression or motion is formed in a case where all the change amounts of the one or more specific portions specified in advance exceed respective threshold values for a predetermined time”.

In a fifth aspect, in the computer program according to any one of the first and fourth aspects, “the processor generates an image or a moving image in which the specific expression corresponding to the determined specific facial expression or motion is reflected on the avatar object corresponding to the performer for a certain time”.

In a sixth aspect, in the computer program according to any one of the first and fifth aspects, “at least one of the specific facial expression or motion, the specific portion corresponding to the specific facial expression or motion, each of the threshold values, a correspondence relationship between the specific facial expression or motion and the specific expression, the predetermined time, and the certain time is set or changed via a user interface”.

In a seventh aspect, in the computer program according to the sixth aspect, “each of the threshold values is set or changed to an arbitrary value for each of the specific portions via the user interface”.

In an eighth aspect, in the computer program according to the sixth aspect, “each of the threshold values is set or changed to any one of a plurality of predetermined values preset for each of the specific portions via the user interface”.

In a ninth aspect, in the computer program according to the sixth aspect, “the user interface includes at least one of a first user interface for setting each of the threshold values to an arbitrary value for each of the specific portions, a second user interface for setting each of the threshold values to any one of a plurality of predetermined values preset for each of the specific portions, and a third user interface for setting the correspondence relationship between the specific facial expression or motion and the specific expression”.

In a tenth aspect, in the computer program according to any one of the sixth to ninth aspects, “at a time of setting or changing at least one of the specific facial expression or motion, the specific portion corresponding to the specific facial expression or motion, each of the threshold values, the correspondence relationship between the specific facial expression or motion and the specific expression, the predetermined time, and the certain time, at least one of image information and character information regarding the specific facial expression or motion is included in the user interface”.

In an eleventh aspect, in the computer program according to any one of the sixth to tenth aspects, “at the time of setting or changing at least one of the specific facial expression or motion, the specific portion corresponding to the specific facial expression or motion, each of the threshold values, the correspondence relationship between the specific facial expression or motion and the specific expression, the predetermined time, and the certain time, in a case where it is determined that the specific facial expression or motion is formed, a first test image or a first test moving image in which the same specific expression as the specific facial expression or motion is reflected on the avatar object is included in the user interface”.

In a twelfth aspect, in the computer program according to the eleventh aspect, “at the time of setting or changing at least one of the specific facial expression or motion, the specific portion corresponding to the specific facial expression or motion, each of the threshold values, the correspondence relationship between the specific facial expression or motion and the specific expression, the predetermined time, and the certain time, in a case where it is determined that the specific facial expression or motion is formed, a second test image or a second test moving image which is same as the first test image or the first test moving image is included over a specific time different from the certain time in the user interface”.

In a thirteenth aspect, in the computer program according to the sixth aspect, “the correspondence relationship between the specific facial expression or motion and the specific expression is a same relationship between the specific facial expression or motion and the specific expression, a similar relationship between the specific facial expression or motion and the specific expression, and an unrelated relationship between the specific facial expression or motion and the specific expression”.

In a fourteenth aspect, in the computer program according to any one of the sixth to thirteenth aspects, “at least one of the specific facial expression or motion, the specific portion corresponding to the specific facial expression or motion, each of the threshold values, the correspondence relationship between the specific facial expression or motion and the specific expression, the predetermined time, and the certain time is changed during distribution of the image or the moving image”.

In a fifteenth aspect, in the computer program according to any one of the first to fourteenth aspects, “the specific portion is a portion of a face”.

In a sixteenth aspect, in the computer program according to the fifteenth aspect, “the specific portion is selected from a group including eyebrows, eyes, eyelids, cheeks, a nose, ears, lips, a tongue, and jaws”.

In a seventeenth aspect, in the computer program according to any one of the first to sixteenth aspects, “the processor is a central processing unit (CPU), a microprocessor, or a graphics processing unit (GPU)”.

In an eighteenth aspect, in the computer program according to any one of the first to seventeenth aspects, “the processor is mounted in a smartphone, a tablet, a mobile phone or a personal computer, or a server device”.

A server device according to a nineteenth aspect “includes: a processor. The processor executes computer readable instructions to perform retrieving a change amount of each of a plurality of specific portions of a body on the basis of data regarding a motion of the body retrieved by a sensor, determining that a specific facial expression or motion is formed in a case where all change amounts of one or more specific portions specified in advance among the change amounts of the plurality of specific portions exceed respective threshold values, and generating an image or a moving image in which a specific expression corresponding to the determined specific facial expression or motion is reflected on an avatar object corresponding to a performer”.

In a twentieth aspect, in the server device according to the nineteenth aspect, “the processor is a central processing unit (CPU), a microprocessor, or a graphics processing unit (GPU)”.

In a twenty-first aspect, in the server device according to the nineteenth or twentieth aspect, “the server device is arranged in a studio”.

A method according to a twenty-second aspect may be “executed by one or more processors executing computer readable instructions. The method includes: a change amount retrieval process of retrieving a change amount of each of a plurality of specific portions of a body on the basis of data regarding a motion of the body retrieved by a sensor; a determination process of determining that a specific facial expression or motion is formed in a case where all change amounts of one or more specific portions specified in advance among the change amounts of the plurality of specific portions exceed respective threshold values; and a generation process of generating an image or a moving image in which a specific expression corresponding to the specific facial expression or motion determined by the determination process is reflected on an avatar object corresponding to a performer”.

In a twenty-third aspect, in the method according to the twenty-second aspect, “the change amount retrieval process, the determination process, and the generation process are executed by the processor mounted on a terminal device selected from a group including a smartphone, a tablet, a mobile phone, and a personal computer”.

In a twenty-fourth aspect, in the method according to the twenty-second aspect, “the change amount retrieval process, the determination process, and the generation process are executed by the processor mounted on a server device”.

In a twenty-fifth aspect, in the method according to any one of the twenty-second to twenty-fourth aspects, “the processor is a central processing unit (CPU), a microprocessor, or a graphics processing unit (GPU).”

A system according to a twenty-sixth aspect may include “a first device which includes a first processor; and a second device which includes a second processor and is connectable to the first device via a communication line. Among a change amount retrieval process of retrieving a change amount of each of a plurality of specific portions of a body on the basis of data regarding a motion of the body retrieved by a sensor, a determination process of determining that a specific facial expression or motion is formed in a case where all change amounts of one or more specific portions specified in advance among the change amounts of the plurality of specific portions exceed respective threshold values, and a generation process of generating an image or a moving image in which a specific expression corresponding to the specific facial expression or motion determined by the determination process is reflected on an avatar object corresponding to a performer, the first process included in the first device executes computer readable instructions to perform at least one process of the change amount retrieval process, the determination process, and the generation process, and in a case where there is any remaining process which is not performed by the first processor, the second processor included in the second device executes computer readable instructions to perform the remaining process.

In a twenty-seventh aspect, in the system according to the twenty-sixth aspect, “the processor is a central processing unit (CPU), a microprocessor, or a graphics processing unit (GPU)”.

In a twenty-eighth aspect, in the system according to the twenty-sixth or twenty-seventh aspect, “the communication line includes the Internet”.

A terminal device according to a twenty-ninth aspect may performs “retrieving a change amount of each of a plurality of specific portions of a body on the basis of data regarding a motion of the body retrieved by a sensor; determining that a specific facial expression or motion is formed in a case where all change amounts of one or more specific portions specified in advance among the change amounts of the plurality of specific portions exceed respective threshold values; and generating an image or a moving image in which a specific expression corresponding to the determined specific facial expression or motion is reflected on an avatar object corresponding to a performer”.

In a thirtieth aspect, in the terminal device according to the twenty-ninth aspect, “the processor is a central processing unit (CPU), a microprocessor, or a graphics processing unit (GPU)”.

7. Fields to which the Technology Disclosed in the Present Application May be Applied

The technology disclosed in the present application may be applied in the following fields, for example.

(1) Application services for distributing a live video in which an avatar object appears;

(2) Application services capable of communicating using characters and avatar objects (chat applications, messenger, mail applications, or the like).

What is claimed is:

1. A non-transitory computer readable medium storing a set of instructions that are executable by one or more processors of a system to cause the system to perform a method comprising:
retrieving a change amount of each of a plurality of specific portions of a body based on data regarding a motion of the body retrieved by a sensor;
determining that a specific facial expression or motion is formed if change amounts of one or more specific portions specified in advance among the change amounts of the plurality of specific portions exceed respective threshold values; and
generating an image or a moving image in which a specific expression corresponding to the determined specific facial expression or motion is reflected on an avatar object corresponding to a performer.

2. The medium according to claim 1, wherein the specific expression includes a specific motion or facial expression.

3. The medium according to claim 1, wherein the body is a body of the performer.

4. The medium according to claim 1, wherein determining that the specific facial expression or motion is formed includes determining if all the change amounts of the one or more specific portions specified in advance exceed respective threshold values for a predetermined time.

5. The medium according to claim 4, wherein generating the image or the moving image includes generating an image or a moving image includes generating an image or a moving image in which the specific expression corresponding to the determined specific facial expression or motion is reflected on the avatar object corresponding to the performer for a certain time.

6. The medium according to claim 5, wherein at least one of the specific facial expression or motion, the specific portion corresponding to the specific facial expression or motion, each of the threshold values, a correspondence relationship between the specific facial expression or motion and the specific expression, the predetermined time, and the certain time is set or changed via a user interface.

7. The medium according to claim 6, wherein each of the threshold values is set or changed to an arbitrary value for each of the specific portions via the user interface.

8. The medium according to claim 6, wherein each of the threshold values is set or changed to any one of a plurality of predetermined values preset for each of the specific portions via the user interface.

9. The medium according to claim 6, wherein the user interface includes at least one of:
a first user interface for setting each of the threshold values to an arbitrary value for each of the specific portions,
a second user interface for setting each of the threshold values to any one of a plurality of predetermined values preset for each of the specific portions, and
a third user interface for setting the correspondence relationship between the specific facial expression or motion and the specific expression.

10. The medium according to claim 6, wherein at a time of setting or changing at least one of the specific facial expression or motion, the specific portion corresponding to the specific facial expression or motion, each of the threshold values, the correspondence relationship between the specific facial expression or motion and the specific expression, the predetermined time, and the certain time, at least one of image information and character information regarding the specific facial expression or motion is included in the user interface.

11. The medium according to claim 6, wherein at the time of setting or changing at least one of the specific facial expression or motion, the specific portion corresponding to the specific facial expression or motion, each of the threshold values, the correspondence relationship between the specific facial expression or motion and the specific expression, the predetermined time, and the certain time, in a case where it is determined that the specific facial expression or motion is formed, a first test image or a first test moving image in which the same specific expression as the specific facial expression or motion is reflected on the avatar object is included in the user interface.

12. The medium according to claim 11, wherein at the time of setting or changing at least one of the specific facial expression or motion, the specific portion corresponding to the specific facial expression or motion, each of the threshold values, the correspondence relationship between the specific facial expression or motion and the specific expression, the predetermined time, and the certain time, in a case where it is determined that the specific facial expression or motion is formed, a second test image or a second test moving image which is same as the first test image or the first test moving image is included over a specific time different from the certain time in the user interface.

13. The medium according to claim 6, wherein the correspondence relationship between the specific facial expression or motion and the specific expression is a same relationship between the specific facial expression or motion and the specific expression, a similar relationship between the specific facial expression or motion and the specific expression, or an unrelated relationship between the specific facial expression or motion and the specific expression.

14. The medium according to claim 6, wherein at least one of the specific facial expression or motion, the specific portion corresponding to the specific facial expression or motion, each of the threshold values, the correspondence relationship between the specific facial expression or motion and the specific expression, the predetermined time, and the certain time is changed during distribution of the image or the moving image.

15. The medium according to claim 1, wherein the specific portion is a portion of a face.

16. The medium according to claim 15, wherein the specific portion is selected from a group including eyebrows, eyes, eyelids, cheeks, a nose, ears, lips, a tongue, and jaws.

17. The medium according to claim 1, wherein the one or more processors includes a central processing unit (CPU), a microprocessor, or a graphics processing unit (GPU).

18. The medium according to claim 1, wherein the one or more processors is mounted in a smartphone, a tablet, a mobile phone or a personal computer, or a server device.

19. A server device comprising:
a processor, wherein
the processor is configured to execute computer readable instructions to perform a method comprising:
retrieving a change amount of each of a plurality of specific portions of a body based on data regarding a motion of the body retrieved by a sensor,
determining that a specific facial expression or motion is formed if change amounts of one or more specific portions specified in advance among the change amounts of the plurality of specific portions exceed respective threshold values, and
generating an image or a moving image in which a specific expression corresponding to the determined specific facial expression or motion is reflected on an avatar object corresponding to a performer.

20. The server device according to claim 19, wherein the processor is a central processing unit (CPU), a microprocessor, or a graphics processing unit (GPU).

21. The server device according to claim 19, wherein the processor includes a plurality of processors.

22. The server device according to claim 19, wherein the server device is arranged in a studio.

23. A method executed by one or more processors executing computer readable instructions, the method comprising:
a change amount retrieval process of retrieving a change amount of each of a plurality of specific portions of a body based on data regarding a motion of the body retrieved by a sensor;
a determination process of determining that a specific facial expression or motion is formed in response to change amounts of one or more specific portions specified in advance among the change amounts of the plurality of specific portions exceeding respective threshold values; and
a generation process of generating an image or a moving image in which a specific expression corresponding to the specific facial expression or motion determined by the determination process is reflected on an avatar object corresponding to a performer.

24. The method according to claim 23, wherein the change amount retrieval process, the determination process, and the generation process are executed by the one or more processors mounted on a terminal device selected from a group including a smartphone, a tablet, a mobile phone, and a personal computer.

25. The method according to claim 23, wherein the change amount retrieval process, the determination process, and the generation process are executed by the one or more processors mounted on a server device.

25. The method according to claim 22, wherein the one or more processors includes a central processing unit (CPU), a microprocessor, or a graphics processing unit (GPU).

26. The medium of claim 1, wherein determining that the specific facial expression or motion is formed includes determining if all the change amounts of the one or more specific portions specified in advance exceed respective threshold values.

27. The server device of claim 19, wherein determining that the specific facial expression or motion is formed includes determining if all the change amounts of the one or more specific portions specified in advance exceed respective threshold values.

28. The method of claim 23, wherein determining that the specific facial expression or motion is formed includes determining if all the change amounts of the one or more specific portions specified in advance exceed respective threshold values.
